(19) United States
(12) Patent Application Publication
(10) Pub. No.: US 2007/0206834 A1
(43) Pub. Date: Sep. 6, 2007

(54) Search system, image-capturing apparatus, data storage apparatus, information processing apparatus, captured-image processing method, information processing method, and program

(76) Inventors: Mitsutoshi Shinkai, Kanagawa (JP); Kotaro Kashiwa, Kanagawa (JP)

Correspondence Address: William S. Frommer, Esq.;FROMMER LAWRENCE & HAUG LLP, 745 Fifth Avenue, New York, NY, 10151, US

(21) Appl. No.: 11/713,769

(22) Filed: Mar. 2, 2007

(30) Foreign Application Priority Data
Mar. 6, 2006 (JP) 2006-059206

(51) Int. Cl. G06K 9/00

(52) U.S. Cl. 382/103; 382/181

(57) ABSTRACT

A search system includes a plurality of image-capturing apparatuses that are fixedly installed at different places; a data storage apparatus; and an information processing apparatus. Each of the image-capturing apparatuses includes an image capturer, a recording and reproduction section, a feature data generator, a transmission data generator, and a transmitter. The data storage apparatus includes a database and a register. The information processing apparatus includes a condition input section, an obtaining section, a classification and extraction section, and a display processor.

### CROSS REFERENCES TO RELATED APPLICATIONS

The present invention contains subject matter related to Japanese Patent Application JP 2006-059206 filed in the Japanese Patent Office on Mar. 6, 2006, the entire contents of which are incorporated herein by reference.

### BACKGROUND OF THE INVENTION

### Field of the Invention

The present invention relates to an image-capturing apparatus, a data storage apparatus, an information processing apparatus, and a search system including the image-capturing apparatus, the data storage apparatus, the information processing apparatus. The present invention also relates to a captured-image processing method and a program used in the image-capturing apparatus and further relates to an information processing method and a program used in the information processing apparatus.

As disclosed in Japanese Unexamined Patent Application Publication Nos. 2003-281157 and 2003-324720, a person search system and a monitor system are known.

In the person search system of Japanese Unexamined Patent Application Publication No. 2003-281157, a technology for searching a database for a specific person and tracking the specific person by using face images of persons, fingerprint images, and the like is disclosed.

In the monitor system of Japanese Unexamined Patent Application Publication No. 2003-324720, a technology for operating a plurality of cameras in synchronization so as to implement monitoring of a moving person or the like is disclosed.

### SUMMARY OF THE INVENTION

However, there is no currently available system suitable for a case in which, for example, it is desired to search for a person who has moved from a particular place to another particular place among an unspecified large number of people.

An example of a criminal investigation is cited. It is assumed that a particular incident has occurred, and the criminal passed through place A and place B while escaping. Then, it is assumed that a monitor camera for continuously performing image capturing has been installed at place A and place B.

In this case, an investigator can reproduce an image captured by the camera at place A, reproduce an image captured by the camera at place B, and make a list of persons who have been image-captured at both A and B places as persons having a possibility of corresponding to the criminal.

However, for this purpose, an operation has to be performed in which the investigator attempts to remember the faces of all the persons who have been image-captured by carefully viewing the captured images at place A for a certain time period and thereafter find persons who have been image-captured by the cameras at both places A and B by viewing the images captured by the camera at place B. The operation is very difficult and requires a great deal of patience. Also, the target person cannot always be found, and the operation takes a long period of time and can be inefficient.

Accordingly, it is desirable to provide a technology capable of searching for subjects (persons or the like) who were present at both of those places when a plurality of places (having image-capturing apparatuses) are input as search conditions.

The search system according to an embodiment of the present invention includes a plurality of image-capturing apparatuses that are fixedly installed at different places, a data storage apparatus, and an information processing apparatus.

The image-capturing apparatuses constituting the search system according to another embodiment of the present invention are image-capturing apparatuses that are fixedly installed at predetermined places and that are capable of communicating with at least an external data storage apparatus, each of the image-capturing apparatuses including: an image capturer configured to obtain image data by performing image capturing; a recording and reproduction section configured to record the image data obtained by the image capturer on a recording medium; a feature data generator configured to analyze the image data obtained by the image capturer and generate feature data of a subject; a transmission data generator configured to generate, as transmission data, a feature data unit containing at least the feature data and image-capturing apparatus identification information given to individual image-capturing apparatuses; and a transmitter configured to transmit the feature data unit generated by the transmission data generator to the data storage apparatus.

The recording and reproduction section may record the image data obtained by the image capturer, together with date and time information indicating image-capturing date and time, on a recording medium.

The transmission data generator may generate a feature data unit containing date and time information indicating image-capturing date and time of image data related to the feature data.

The transmission data generator may further generate a feature data unit containing image data related to the feature data.

The feature data generator may extract image data corresponding to a person as a subject of the image data obtained by the image capturer and may generate feature data regarding the person on the basis of the extracted image data.

The image-capturing apparatus may further include a sensor configured to detect information regarding a subject captured by the image capturer, wherein the feature data generator generates the feature data on the basis of the detection information obtained by the sensor.

The image-capturing apparatus may further include an image transmission controller configured to, in response to image request information received from an external information processing apparatus, allow the recording and reproduction section to read image data specified by the image request information and allow the communication section to transmit the image data to the information processing apparatus.

The image-capturing apparatus may further include a search process controller configured to perform a process for setting feature data contained in the search request information as an object to be searched for in response to search request information received from an external information processing apparatus; and a process for determining whether or not the feature data generated by the feature data generator matches the feature data that is set as an object to be searched for and for making a notification to the information processing apparatus when the feature data match.

The image-capturing apparatus may further include an amount-of-data-reduction process controller configured to allow the recording and reproduction section to perform an amount-of-stored-data-reduction process for reducing the amount of image data for which a predetermined period of time has passed from the time of recording from within the image data recorded on the recording medium.

The data storage apparatus constituting the search system according to another embodiment of the present invention are a data storage apparatus capable of communicating with a plurality of image-capturing apparatuses that are fixedly installed at different places. The data storage apparatus includes: a database; and a register configured to register feature data units transmitted from the image-capturing apparatuses in the database so as to be stored.

The information processing apparatus constituting the search system according to another embodiment of the present invention includes: a condition input section configured to accept, as input conditions, an input for specifying plural image-capturing apparatus among a plurality of image-capturing apparatuses that are fixedly installed at different places; an obtaining section configured to obtain a feature data unit related to each image-capturing apparatus specified by the process of the condition input section from a database in which feature data units that are generated by the plurality of image-capturing apparatuses and that contain the feature data of subjects are registered; a classification and extraction section configured to classify each feature data unit obtained by the obtaining section on the basis of the feature data contained in the feature data unit and configured to extract a plurality of feature data units having identical or similar feature data as a feature data group; and a display processor configured to display and output information on the feature data group extracted by the classification and extraction section.

The condition input section may accept, as input conditions, the specifying of a plurality of image-capturing apparatuses and also the specifying of date and time for each image-capturing apparatus, and the obtaining section may obtain the feature data unit corresponding to the date and time specified by each specified image-capturing apparatus from the database.

The information processing apparatus may further include an image request transmitter configured to transmit image request information for making a request for an image corresponding to a feature data unit contained in the feature data group extracted by the classification and extraction section to the image-capturing apparatus that has generated the feature data unit, wherein the display processor displays and outputs the image data transmitted from the image-capturing apparatus in response to the image request information.

The information processing apparatus may further include a search request transmitter configured to generate search request information containing the feature data in the feature data unit and transmit the search request information to each of the image-capturing apparatuses.

The captured-image processing method for use with the image-capturing apparatuses according to another embodiment of the present invention includes the steps of: obtaining image data by performing image capturing; recording the image data obtained in the image capturing on a recording medium; analyzing the image data obtained in the image capturing and generating feature data of a subject; generating, as transmission data, a feature data unit containing at least the feature data and image-capturing apparatus identification information given to individual image-capturing apparatuses; and transmitting the feature data unit generated in the transmission data generation to the data storage apparatus.

The information processing method for use with the image-capturing apparatuses according to another embodiment of the present invention includes the steps of: accepting, as input conditions, an input for specifying plural image-capturing apparatus among a plurality of image-capturing apparatuses that are fixedly installed at different places; obtaining a feature data unit related to each image-capturing apparatus specified in the condition input from a database in which feature data units that are generated by the plurality of image-capturing apparatuses and that contain the feature data of subjects are registered; classifying each feature data unit obtained in the obtainment on the basis of the feature data contained in the feature data unit and extracting a plurality of feature data units having identical or similar feature data as a feature data group; and displaying and outputting information on the feature data group extracted in the classification and extraction.

The program according to another embodiment of the present invention is a program for enabling an image-capturing apparatus to perform the captured-image processing method.

The program according to another embodiment of the present invention is a program for enabling the information processing apparatus to perform the information processing method.

In the present invention described in the foregoing, a large number of image-capturing apparatuses are fixedly installed at different places. The image-capturing apparatuses, for example, continuously capture images at the places where they are fixedly installed, so that captured image data is recorded and also the feature data of persons or the like contained in the captured image data is generated. After the feature data is generated, a feature data unit containing the feature data, image-capturing apparatus identification information, and information containing the image-capturing date and time is generated, and this feature data unit is transmitted to the data storage apparatus.

When each image-capturing apparatus performs such an operation, a large number of feature data units are transmitted from each image-capturing apparatus to the data storage apparatus, and the data storage apparatus registers and stores the feature data units in the database. That is, in the database, the feature data of persons and the like, captured by image-capturing apparatuses at each place, is stored.

The information processing apparatus can perform searches so that persons or the like matching selected conditions are determined from the database. For example, a person who moved from place A to place B is searched for. In this case, an image-capturing apparatus installed at place A and an image-capturing apparatus installed at place B are specified. Then, the feature data unit generated by the image-capturing apparatus at place A and the feature data unit generated by the image-capturing apparatus at place B are extracted from the database, and identical or similar feature data units having identical or similar feature data at the two places are grouped as a feature data group. There is a high probability that the plurality of grouped feature data units have the same person as a subject. Then, by displaying and outputting the information of each feature data unit in the feature data group, it is possible to confirm the person who moved from place A to place B as a search result.

According to embodiments of the present invention, by specifying a plurality of places (places where image-capturing apparatuses are fixedly installed), it is possible to find persons or the like as a subject who were present at the plurality of places. That is, a search for finding an unknown person who was present at a particular place becomes possible. As a result, for example, a search effective for a criminal investigation or the like can be performed.

### BRIEF DESCRIPTION OF THE DRAWINGS

FIG. 1 is an illustration of a search system according to an embodiment of the present invention;

FIG. 2 is a block diagram of an image-capturing apparatus according to an embodiment of the present invention;

FIGS. 3A and 3B are illustrations of a feature data unit according to an embodiment of the present invention;

FIG. 4 is a block diagram of a computer system for implementing a search processing apparatus according to an embodiment of the present invention;

FIGS. 5A and 5B are block diagrams of the functional structure of a data storage server and a search processing apparatus according to an embodiment of the present invention;

FIG. 6 is an illustration of a feature data DB according to an embodiment of the present invention;

FIG. 7 is a flowchart of processing at the time of image capturing according to an embodiment of the present invention;

FIG. 8 is a flowchart at the time of a search according to an embodiment of the present invention;

FIG. 9 is a flowchart of a search result display process according to an embodiment of the present invention;

FIG. 10 is a flowchart of processing at the time of an image request according to an embodiment of the present invention;

FIG. 11 is a flowchart of processing at the time of a search request according to an embodiment of the present invention;

FIG. 12 is an illustration of a state when a search according to the embodiment is performed;

FIG. 13 is an illustration of feature data units obtained from a database at the time of a search according to an embodiment of the present invention;

FIGS. 14A, 14B, and 14C are illustrations of a process for comparing feature data units according to an embodiment of the present invention;

FIG. 15 is an illustration of a process for classifying feature data units according to an embodiment of the present invention;

FIG. 16 is an illustration of a search result list display according to an embodiment of the present invention;

FIGS. 17A and 17B are illustrations of detailed displays according to an embodiment of the present invention;

FIG. 18 is an illustration of a reproduced image display according to an embodiment of the present invention;

FIG. 19 is an illustration of face data according to an embodiment of the present invention;

FIG. 20 is an illustration of an example of specifying image-capturing apparatuses according to an embodiment of the present invention;

FIG. 21 is an illustration of an example of specifying image-capturing apparatuses according to an embodiment of the present invention; and

FIG. 22 is a flowchart of an amount-of-stored-data-reduction process according to an embodiment of the present invention.

### DESCRIPTION OF THE PREFERRED EMBODIMENTS

Embodiments of the present invention will be described below in the following order.
1. Configuration of search system
2. Configuration of image-capturing apparatus
3. Configuration of search processing apparatus and data storage server
4. Storage of feature data
5. Search for person using feature data
6. Feature data and determination as to similarity thereof
7. Example of specification of image-capturing apparatus in search
8. Data storage in image-capturing apparatus
9. Advantages of embodiments, and modifications
   1. Configuration of Search System

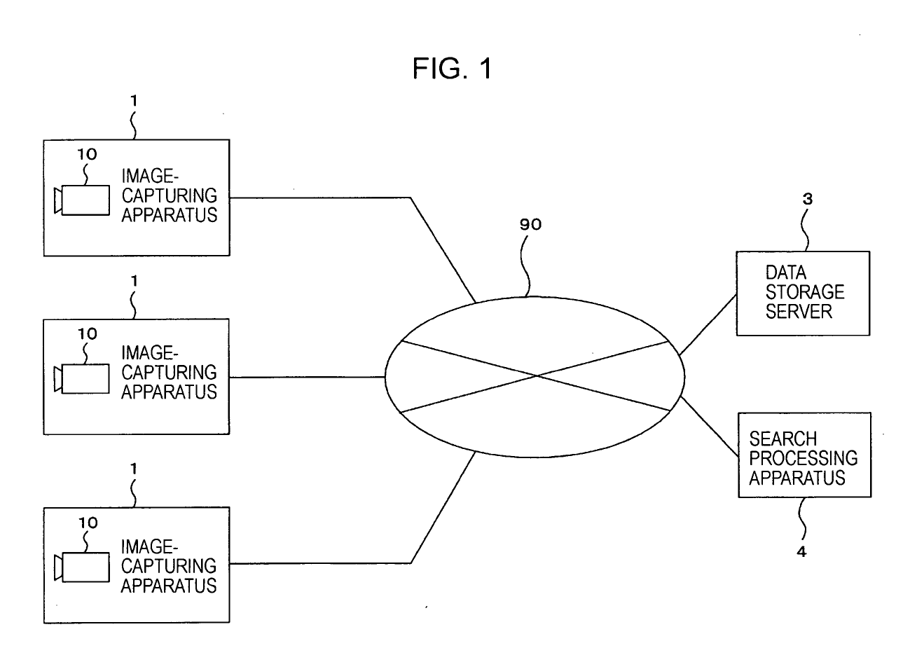

A search system according to an embodiment of the present invention is schematically shown in FIG. 1.

The search system is configured in such a way that a large number of image-capturing apparatuses 1, a data storage server 3, and a search processing apparatus 4 are connected to one another so as to be capable of performing data communication via a network 90.

Each of the image-capturing apparatuses 1 is installed to capture a video image at a specific place by a camera section 10. Each image-capturing apparatus is installed to capture images of the surroundings at a specific place, such as an intersection of streets, a desired place in busy streets, in front of a station, and the ticket gates of a station, in particular, to capture images of persons in the area thereof. Then, each image-capturing apparatus 1 is assumed to continuously perform image capturing.

The data storage server 3 registers feature data units transmitted from each image-capturing apparatus 1 in a feature data database (hereinafter also referred to as a “feature data DB”) so as to be stored.

On the basis of the input conditions, the search processing apparatus 4 searches the feature data units registered in the feature data DB of the data storage server 3 for a feature data unit. For the network 90, a public network, such as the Internet, may be used. In the case of police usage, a dedicated network would be constructed.

The data storage server 3 and the search processing apparatus 4 are shown as separate apparatuses. However, these may be constituted by an integral computer system. Furthermore, the data storage server 3 and the search processing apparatus 4 may communicate with each other via a LAN (Local Area Network) inside a police station in place of the network 90.

The operation outline of the search system is as follows.

Each image-capturing apparatus 1 continuously captures images at an installation place. Then, each image-capturing apparatus 1 records the captured image data and also generates the feature data of each of the persons, contained in the captured image data. The feature data refers to the features of the face of the person as a subject, the color of the clothes, and the like. Furthermore, a desired sensor may be provided so that features that can be detected from other than the images is contained in the feature data.

When the feature data is generated, the image-capturing apparatus 1 creates a feature data unit containing the feature data, a camera ID as identification information that is individually provided to the image-capturing apparatus 1, date and time information indicating image-capturing date and time, and transmits this feature data unit to the data storage server 3.

As a result of each image-capturing apparatus 1 continuously performing such an operation, a large number of feature data units are transmitted from the image-capturing apparatuses 1 to the data storage server 3. The data storage server 1 registers and stores all the feature data units that have been transmitted and received in the feature data DB.

As a result, in the feature data DB, feature data of persons whose images have been captured by the image-capturing apparatuses installed at various places is stored.

It is possible for the search processing apparatus 4 to search for a person whose whereabouts at a certain time can be specified or deduced. For example, it is assumed that it is desired to infer whether a person who was present at place A on Jan. 5, 2006, at around 10:30 was also present at place B around 11:00, which is about 30 minutes thereafter.

In this case, the user of the search processing apparatus 4 inputs the conditions of the image-capturing apparatus 1 at place A and time (around 10:30) and the conditions of the image-capturing apparatus 1 at place B and time (around 11:00).

The search processing apparatus 4 obtains all the feature data units corresponding to the above-described conditions from the feature data DB in the data storage server 3. That is, all the feature data units containing the feature data generated from the image captured around 10:30 by the image-capturing apparatus 1 at place A and all the feature data units containing the feature data generated from the images captured around 11:00 by the image-capturing apparatus 1 at place B are obtained.

Then, the search processing apparatus 4 classifies the feature data contained in the individual feature data units and forms feature data units containing common feature data (identical or similar feature data) as a feature data group.

When a plurality of feature data units are formed as a group, there is a high probability that the same person is the subject in each feature data unit. Therefore, the information on each feature data unit in the feature data group is displayed and output as a search result. Here, the information on one feature data group, which is displayed as a search result, indicates the features of the person who moved from place A to place B.

2. Configuration of Image-Capturing Apparatus

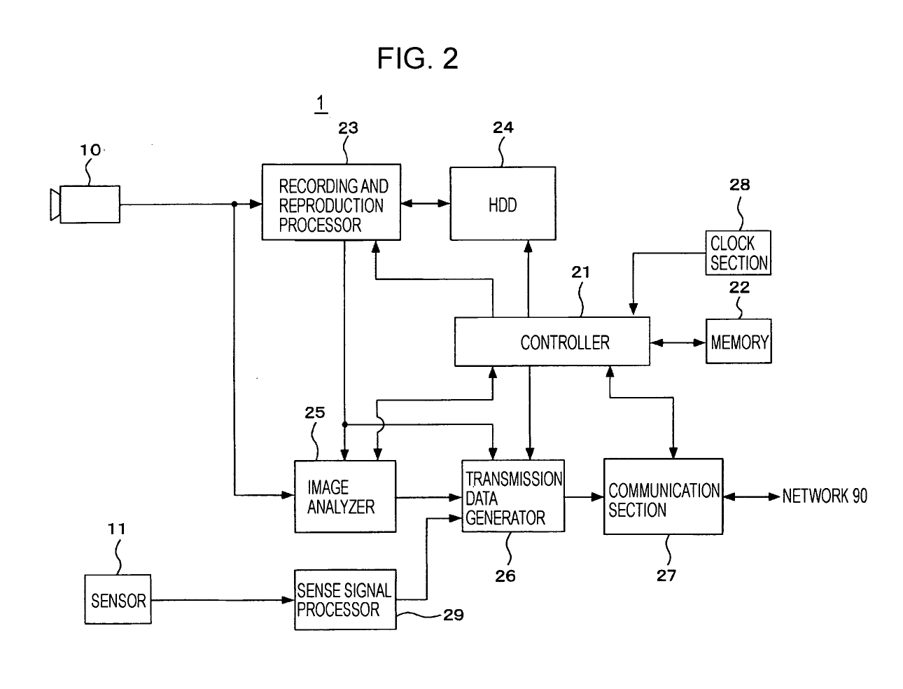

An example of the configuration of the image-capturing apparatus 1 that is installed at each place is shown in FIG. 2.

A controller (Central Processing Unit: CPU) 21 performs the entire operation control of the image-capturing apparatus 1. The controller 21 controls each section in accordance with an operation program in order to realize various kinds of operations (to be described later).

A memory section 22 is a storage device used to store program code to be executed by the controller 21 and used to temporarily store work data during execution of the program code. In the case of FIG. 2, the memory section 22 is shown as including both a volatile memory and a non-volatile memory. Examples thereof include a ROM (Read Only Memory) in which a program is stored, a RAM (Random Access Memory) serving as a computation work area and enabling various kinds of temporary storage, and a non-volatile memory such as an EEP-ROM (Electrically Erasable and Programmable Read Only Memory).

A clock section 28 generates current date and time information, that is, continuously counts current year/month/day/hour/minute/second. The controller 21 supplies the date and time information of year/month/day/hour/minute/second counted by the clock section 28 to a recording and reproduction processor 23 and a transmission data generator 26.

The camera section 10 captures an image of the surroundings at the place where the image-capturing apparatus 1 is installed as a subject of image capturing. The camera section 10 is formed in such a way that an image-capturing optical lens system, a lens drive system, an image-capturing element using a CCD sensor and a CMOS sensor, an image-capturing signal processing circuit system, and the like are incorporated therein. The camera section 10 detects the incident image-capturing light by using an image-capturing element and outputs a corresponding captured-image signal. Then, in the image-capturing signal processing circuit system, predetermined signal processing, such as sampling, gain adjustment, white balance processing, correction processing, luminance processing, and color processing, is performed, and the signal is output as captured-image data.

The image data output from the camera section 10 is supplied to the recording and reproduction processor 23 and an image analyzer 25.

Under the control of the controller 21, the recording and reproduction processor 23 performs processing for recording image data supplied from the camera section 10 and processing for reading an image file recorded on a recording medium. Here, as a recording medium, an HDD (Hard Disk Drive) 24 is cited as an example.

During recording, a data compression process using a predetermined compression method is performed on the supplied captured-image data, and a process is performed for encoding the supplied captured-image data into a recording format at which the image data is recorded onto the HDD 24.

The camera section 10, for example, continuously performs an image-capturing operation as moving image capturing and supplies image data. The recording and reproduction processor 23 records the image data in the HDD 24 and attaches a time code to each frame forming the moving image. In this case, in the time code, not only relative time information in which the image-capturing start time is set as 0 hours 0 minutes 0 seconds 0 frame, but also the actual date and time information counted by the clock section 28 is recorded. That is, it is the information of year/month/day/hour/minute/second/frame.

When the image data recorded in the HDD 24 is to be reproduced, the recording and reproduction processor 23 performs a decoding process on the image data read from the HDD 24.

The image analyzer 25 performs an analysis process on the image data supplied from the camera section 10. The image analyzer 25 performs a process for extracting an image portion of a person as an object to be processed from the captured image data and a process for generating feature data from the image portion of the person.

The feature data to be generated by image analysis refers to the features of faces, the colors of the clothes, heights, and the like. These will be described in detail later.

The image analyzer 25 supplies the generated feature data to the transmission data generator 26.

Depending on the place where the camera section 10 is installed and the direction of the subject, a plurality of persons may be photographed within one image-captured screen. When images of a plurality of persons are extracted from one image screen, the image analyzer 25 generates feature data for each person.

The image analyzer 25 is assumed to perform an analysis process on the image data supplied from the camera section 10. Depending on the time required for the image analysis process, it is assumed that it is difficult for the image analyzer 25 to analyze each of the frame images that are continuously supplied from the camera section 10 in real time. For this reason, frames may be extracted at predetermined intervals from within all the frames forming the moving image and may be set as an object to be analyzed. Furthermore, the image data that is temporarily recorded in the HDD 24 may be read, and the image data may be supplied from the recording and reproduction processor 23 to the image analyzer 25 so that an image analysis process is performed on the read image data. For example, by reproducing image data from the HDD 24 in accordance with the time required for the analysis process in the image analyzer 25 and by performing image analysis, it is possible to cope with the analysis process even if analysis takes some time.

A sensor 11 is a detection device for generating feature data regarding a person who served as a subject in a detection process other than image analysis. For example, a weight measuring device (pressure sensor) disposed on a floor, a metal detector, or the like is would be used.

For example, the camera section 10 is assumed to be installed so as to be directed toward the ticket gates of a station. In this case, a weight measuring device or a metal detector installed on the floor part of the ticket gates is the sensor 11.

When a weight measuring device is assumed as the sensor 11, the weight of the person contained in the image can be detected as a body weight detected in synchronization with the image-capturing timing of the image data obtained by the camera section 10. A sense signal processor 29 processes numerical values from the sensor 11 as feature data and supplies it to the transmission data generator 26.

The transmission data generator 26 generates the feature data unit containing the feature data supplied from the image analyzer 25 and the sense signal processor 29 as transmission data to be transmitted to the data storage server 3 shown in FIG. 1.

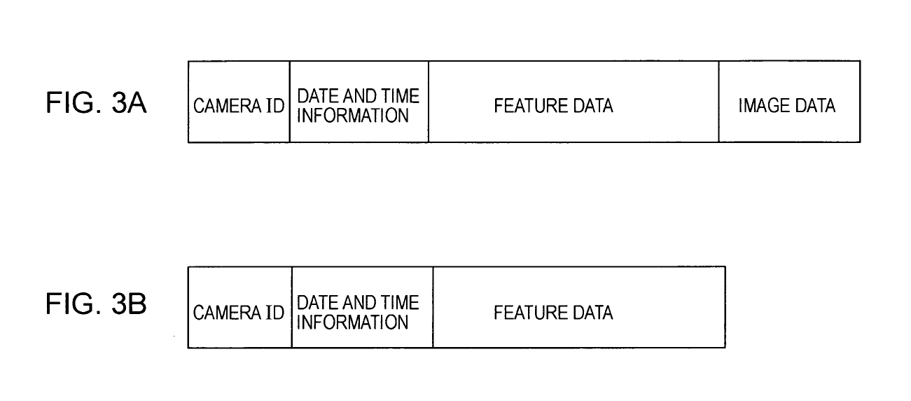

An example of the structure of the feature data unit is shown in FIGS. 3A and 3B.

FIG. 3A shows an example in which a feature data unit is formed of camera ID, date and time information, feature data, and image data. FIG. 3B shows an example in which a feature data unit is formed of camera ID, date and time information, and feature data.

For the structure of the feature data unit, the structure of one of FIGS. 3A and 3B may be adopted. When, in particular, a network communication load and database storage capacity burden of the data storage server 3 are to be reduced, the structure of FIG. 3B may be used. When these loads do not need to be considered, the structure of FIG. 3A may be used.

The camera ID refers to identification information given to the individual image-capturing apparatuses 1 and is stored in a non-volatile memory area of the memory section 22, for example, at manufacturing time, at set-up time, or the like. The camera ID also serves as identification information indicating the place where the image-capturing apparatus 1 is actually installed.

The date and time information is information of year/month/day/hour/minute/second counted by the clock section 28, and is information on image-capturing date and time of the image data when feature data was generated in the image analyzer 25.

The feature data includes data indicating features of the faces of the persons and the colors of the clothes, and feature data generated by the sense signal processor 29.

When the feature data contains image data as shown in FIG. 3A, the image data is an image from which the feature data has been generated, that is, for example, image data of one frame in which the person for which the feature data is generated is photographed. In this case, the image analyzer 25 supplies the feature data and also the original image data from which the feature data has been generated to the transmission data generator 26, whereby it is contained in the feature data unit.

Furthermore, in order to generate transmission image data in response to an image request from the search processing apparatus 4, the transmission data generator 26 also performs an encoding process for the purpose of communicating image data that is reproduced from the HDD 24 and that is supplied from the recording and reproduction processor 23, and a process for generating detection notification data in response to a search request from the search processing apparatus 4.

Under the control of the controller 21, a communication section 27 performs a communication process with the data storage server 3 and the search processing apparatus 4 via the network 90.

When the feature data unit of FIG. 3A or 3B is generated in the transmission data generator 26, this feature data unit is supplied to the communication section 27 and is transmitted to the data storage server 3 by the transmission process of the communication section 27.

Furthermore, when the communication section 27 receives an image request or a search request from the search processing apparatus 4, the communication section 27 performs a process for transmitting the request information to the controller 21, a process for transmitting the image data in response to the image request, and a process for transmitting a detection notification in response to the search request.

The controller 21 controls each of these sections so that operation to be described later is performed.

The controller 21 performs the following control processes: image-capturing operation control of the camera section 10, recording and reproduction instructions for the recording and reproduction processor 23, analysis operation control of the image analyzer 25, instructions for the transmission data generator 26 to generate transmission data (feature data unit and notification information), and communication operation control of the communication section 27.

Furthermore, the controller 21 performs image transmission control. This is processing such that, in response to an image request from the search processing apparatus 4, the recording and reproduction processor 23 reproduces necessary image data and supplies the reproduced image data to the transmission data generator 26, whereby an encoding process is performed as transmission image data, and this data is transmitted from the communication section 27 to the search processing apparatus 4.

Furthermore, the controller 21 performs search process control. This involves a process that, in response to a search request information from the search processing apparatus 4, the feature data contained in the search request information is set as an object to be searched for, and that it is determined whether or not the feature data generated by the image analyzer 25 corresponds to feature data set as an object to be searched for and when the feature data correspond, the transmission data generator 26 generates detection notification information and transmits this information from the communication section 27 to the search processing apparatus 4.

Furthermore, the controller 21 performs amount-of-data-reduction process control. This involves a process of reducing the amount of the image data recorded in the HDD 24 and a process of allowing the HDD 24 and the recording and reproduction processor 23 to perform a necessary operation so that the amount of the image data for which a predetermined period of time has passed from the time of recording within the image data recorded in the HDD 24 is reduced.

The image-capturing apparatus 1 of this embodiment is configured in the manner described above. In addition, various modifications of the configuration can be considered. All the component elements shown in FIG. 2 are not necessarily required, and other component elements may be added.

When the feature data is to be generated by only the image analyzer 25, the sensor 11 and the sense signal processor 29 may not be provided.

Each of the image analyzer 25, the transmission data generator 26, the sense signal processor 29, and the clock section 28 may be configured in terms of hardware as circuit sections separate from the controller 21 (CPU), as shown in FIG. 2. Processing of each of these sections is possible by using a so-called software computation process and may be implemented as a function implemented by a software program in the controller 21.

Furthermore, a microphone may be provided so that captured-image data is recorded and also audio at the surroundings is recorded and transmitted.

Furthermore, the camera section 10 may be formed with a pan and tilt function and a zoom mechanism so that the image-capturing direction can be changed vertically and horizontally and the angle of view can be changed.

The pan and tilt operation and the zoom operation may be performed in response to an operation by a system administrator or the like and may be automatically controlled by the controller 21.

As an example of a recording medium, the HDD 24 is cited. Without being limited to the HDD 24, for example, a recording medium such as an optical disc, a magneto-optical disc, a solid-state memory, or a magnetic tape may be used.

3. Configuration of Search Processing Apparatus and Data Storage Server

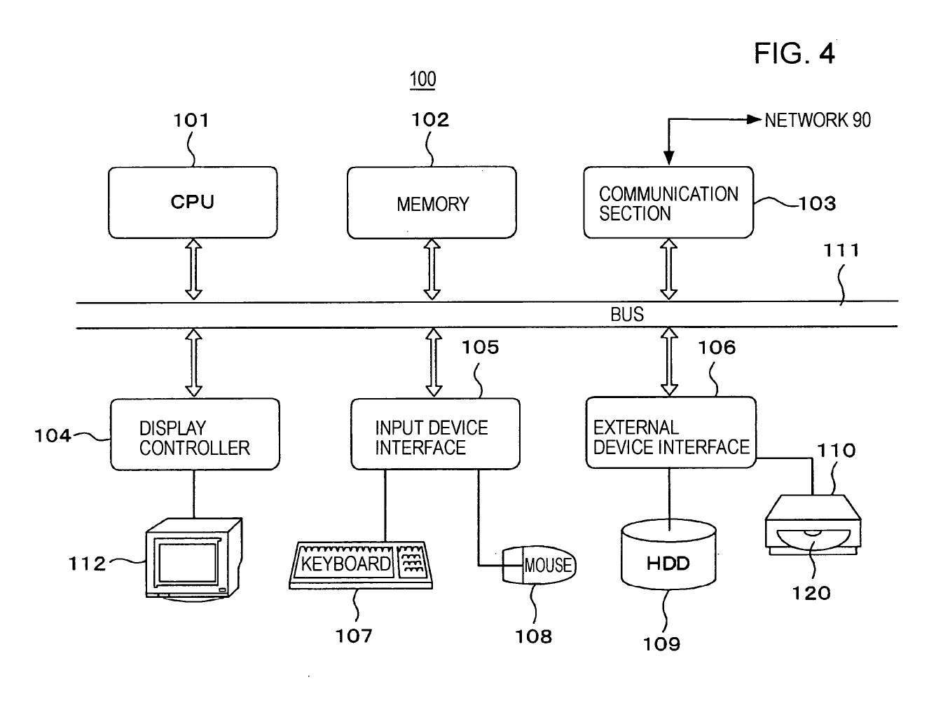

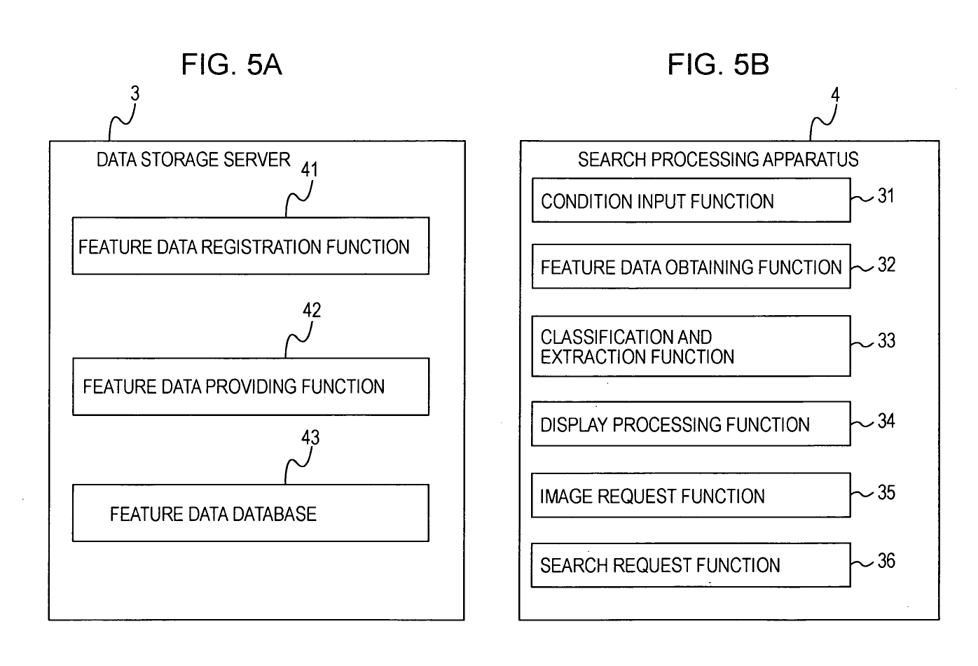

The configuration of the search processing apparatus 4 and the data storage server 3 will be described with reference to FIGS. 4, 5, and 6. The search processing apparatus 4 and the data storage server 3 can be implemented by a computer system as a personal computer and a work station in terms of hardware. First, FIG. 4 illustrates the configuration of a computer system 100 that can be used as the search processing apparatus 4 and the data storage server 3. FIG. 5 illustrates the structure of functions as the data storage server 3 and the search processing apparatus 4.

FIG. 4 schematically shows an example of hardware configuration of the computer system 100. As shown in FIG. 4, the computer system 100 includes a CPU 101, a memory 102, a communication section (network interface) 103, a display controller 104, an input device interface 105, an external device interface 106, a keyboard 107, a mouse 108, an HDD (Hard Disc Drive) 109, a media drive 110, a bus 111, and a display device 112.

The CPU 101 that is a main controller of the computer system 100 performs various kinds of applications under the control of an operating system (OS). For example, when the computer system 100 is used as the search processing apparatus 4, an application for implementing a condition input function 31, a feature data obtaining function 32, a classification and extraction function 33, a display processing function 34, an image request function 35, and a search request function 36, described with reference to FIG. 5B, in the computer system 100 is performed by the CPU 101. Furthermore, when the computer system 100 is used as the data storage server 3, an application for implementing a feature data registration function 41, a feature data provision function 42, and a feature data DB 43 of FIG. 5A in the computer system 100 is performed by the CPU 101.

As shown in FIG. 4, the CPU 101 is interconnected with the other devices via a bus 111. A unique memory address or an I/O address is assigned to each of the devices in the bus 111, so that the CPU 101 can access the devices using the address. An example of the bus 111 is a PCI (Peripheral Component Interconnect) bus.

The memory 102 is a storage device used to store program code executed by the CPU 101 and temporarily store work data during execution of the program code. In the case of FIG. 4, the memory 102 is shown as including both a volatile memory and a non-volatile memory. Examples of the memory 102 include a ROM for storing programs, a RAM for a computation work area and for various temporary storage, and a non-volatile memory such as an EEP-ROM.

In accordance with a predetermined communication protocol such as Ethernet (registered trademark), the communication section 103 allows the computer system 100 to be connected to the network 90 that communicates with the image-capturing apparatus 1 and the like, the network 90 serving as the Internet, a LAN (Local Area Network), or a dedicated line. In general, the communication section 103 serving as a network interface is provided in the form of a LAN adaptor card and is used by being loaded into a PCI bus slot on the motherboard (not shown). In addition, the computer system 100 can also be connected to an external network via a modem (not shown) in place of a network interface.

The display controller 104 is a dedicated controller for actually processing a drawing command issued by the CPU 101, and supports a bit-map drawing functions equivalent to, for example, SVGA (Super Video Graphic Array) or XGA (extended Graphic Array). Drawing data processed by the display controller 104 is temporarily written into a frame buffer (not shown) and thereafter is output on the screen of a display device 112. Examples of the display device 112 include a CRT (Cathode Ray Tube) display device and a liquid-crystal display (LCD) device.

The input device interface 105 is a device used to connect user input devices, such as a keyboard 107 and a mouse 108, to the computer system 100. For example, operation input by an operator in charge of the search processing apparatus 4 in a police station or the like is performed using the keyboard 107 and the mouse 108 in the computer system 100.

The external device interface 106 is a device used to connect external devices, such as the hard disk drive (HDD) 109 and the media drive 110 to, the computer system 100. The external device interface 106 complies with an interface standard, such as IDE (Integrated Drive Electronics) or SCSI (Small Computer System Interface).

The HDD 109, as is well known, is an external storage device in which a magnetic disk as a storage carrier is fixedly installed, and is superior to other external storage devices in terms of a storage capacity and a data transfer rate. Placing a software program in an executable state in the HDD 109 is called “install” of a program into a system. Usually, in the HDD 109, program code of the operating system, which should be executed by the CPU 101, application programs, device drivers, and the like are stored in a non-volatile manner.

For example, an application program for each function performed by the CPU 101 is stored in the HDD 109. Furthermore, in the case of the data storage server 3, the feature data DB 43 is constructed in the HDD 109.

The media drive 110, to which a portable medium 120 such as a CD (Compact Disc), a MO (Magneto-Optical disc), or a DVD (Digital Versatile Disc) is loaded, is a device for accessing the data recording surface thereof. The portable medium 120 is mainly used to back up software programs and data files as computer-readable data and used to move them (including sales and distribution) among systems.

For example, an application that implements each function described with reference to FIG. 5 can be distributed by using the portable medium 120.

For example, the structure of the functions of the data storage server 3 and the search processing apparatus 4 that are constructed using such a computer system 100 are shown in FIGS. 5A and 5B. As shown in FIG. 5A, for the data storage server 3, the feature data registration function 41, the feature data provision function 42, and the feature data DB (database) 43 are provided in the computer system 100.

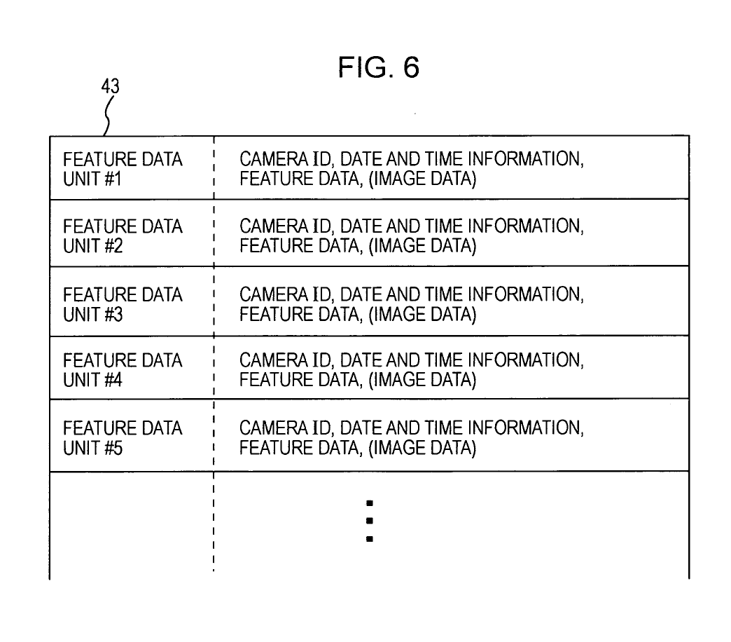

The feature data DB 43 is a database in which all feature data units transmitted as desired from a large number of image-capturing apparatuses 1 are stored. FIG. 6 shows a state in which feature data units are stored in the feature data DB 43.

As shown in FIGS. 3A and 3B, each feature data unit contains a camera ID, date and time information, and feature data. In addition, in the case of FIG. 3A, the feature data unit also contains image data, and all the feature data units containing these pieces of information are stored.

As the actual database management structure, it is appropriate that each feature data unit is managed for each camera ID and in the order of date and time information.

The feature data registration function 41 is a function that is implemented mainly by the operation of the communication section 103, the CPU 101, the memory 102, the external device interface 106, and the HDD 109, and is a function for receiving a feature data unit that is transmitted as desired from each of a large number of image-capturing apparatuses 1, for decoding the feature data unit, and for registering the information content of the feature data unit in the feature data DB 43, as shown in FIG. 6.

The feature data providing function 42 is a function that is implemented mainly by the operation of the communication section 103, the CPU 101, the memory 102, the external device interface 106, and the HDD 109, and is a function for extracting, in response to a data request from the search processing apparatus 4, a feature data unit corresponding to the request from the feature data DB 43, and for transmitting the extracted feature data unit to the search processing apparatus 4.

The search processing apparatus 4, as shown in FIG. 5B, is provided with a condition input function 31, a feature data obtaining function 32, a classification and extraction function 33, a display processing function 34, an image request function 35, and a search request function 36.

The condition input function 31 is a function that is implemented mainly by the operation of the keyboard 107, the mouse 108, the input device interface 105, the display controller 104, the display device 112, the CPU 101, and the memory 102, and is a function for accepting condition inputs from the operator for the purpose of a search process. Examples of condition inputs include an input for specifying a plurality of image-capturing apparatuses 1 (camera IDs) installed at different places and a time period (date and time) and a condition input for narrowing down. The CPU 101 allows the display device 112 to display an input condition screen and also accepts information on the input made by the operator by using the keyboard 107 and the mouse 108 in response to information displayed on the screen.

The feature data obtaining function 32 is a function that is implemented mainly by the operation of the CPU 101, the memory 102, the communication section 103, the external device interface 106, and the HDD 109, and is a function for making a request for a feature data unit to the data storage server 3, thereby obtaining the feature data unit.

The CPU 101 transmits the data request indicating the conditions (the camera ID, and the date and time) accepted by the condition input function 31 from the communication section 103 to the data storage server 3. Then, the CPU 101 allows the communication section 103 to receive the feature data unit transmitted from the data storage server 3 and store it in, for example, the HDD 109 or the memory 102.

That is, the feature data obtaining function 32 is a function for obtaining a feature data unit corresponding to each image-capturing apparatus and the time specified in the process of the condition input function 31 from the feature data DB 43.

The classification and extraction function 33 is a function that is implemented mainly by the operation of the CPU 101, the memory 102, the external device interface 106, and the HDD 109, and is a function for classifying a plurality of feature data units obtained from the data storage server 3 by the feature data obtaining function 32 according to the degrees of sameness or difference of the feature data thereof and for extracting a plurality of feature data units having identical or similar feature data as a feature data group.

That is, the CPU 101 compares the feature data of many obtained feature data units with one another in order to determine whether or not feature data units having identical or similar feature data obtained by different image-capturing apparatuses 1 exist. If they exist, the CPU 101 performs a process for grouping feature data units having identical or similar feature data obtained by different image-capturing apparatuses 1 as a feature data group.

The classification result of the classification and extraction process and the information on the grouping result are held in the memory 102 or the HDD 109.

The display processing function 34 is a function that is implemented mainly by the operation of the display controller 104, the display device 112, the CPU 101, the memory 102, the keyboard 107, the mouse 108, and the input device interface 105, and is a function for displaying and outputting the information on the feature data group extracted as a result of the processing by the classification and extraction function 33.

The CPU 101 supplies, as display data, the information on the feature data unit contained in the feature data group corresponding to the search condition as a feature data group that is grouped to the display controller 104, and allows the display device 112 to perform a list display and a detailed display. At the time of display, the display content is switched in response to operation input for specifying an operation button, an icon, or the like on the screen.

The image request function 35 is a function that is implemented mainly by the operation of the CPU 101, the memory 102, the communication section 103, the HDD 109, the external device interface 106, the display controller 104, the display device 112, the keyboard 107, the mouse 108, and the input device interface 105, and is a function for making a request for the actually captured image data with regard to the feature data unit of the feature data group displayed as a search result to the image-capturing apparatus 1.

For example, while the feature data unit is being displayed, when an operation for making a request for the display of an image corresponding to the feature data unit is performed, the CPU 101 allows the image-capturing apparatus 1 that has generated the feature data unit to transmit an image request from the communication section 103. Then, the image data transmitted from the image-capturing apparatus 1 in response to the image request is received by the communication section 103, and after the image data is stored in, for example, the HDD 109, it is displayed and reproduced in response to the operation of the user.

The search request function 36 is a function that is implemented mainly by the operation of the CPU 101, the memory 102, the communication section 103, the HDD 109, the external device interface 106, the display controller 104, the display device 112, the keyboard 107, the mouse 108, and the input device interface 105, and is a function for transmitting the feature data of the feature data unit (feature data group) displayed as a search result to all the image-capturing apparatuses 1 (do not need to be all the image-capturing apparatuses 1) and for making a request for a process for searching for the person corresponding to the feature data.

Furthermore, the search request function 36 receives notification information notified by the process on the image-capturing apparatus 1 side, which corresponds to the search request, and performs a display output.

4. Storage of Feature Data

The operation of the search system according to this embodiment will be described below.

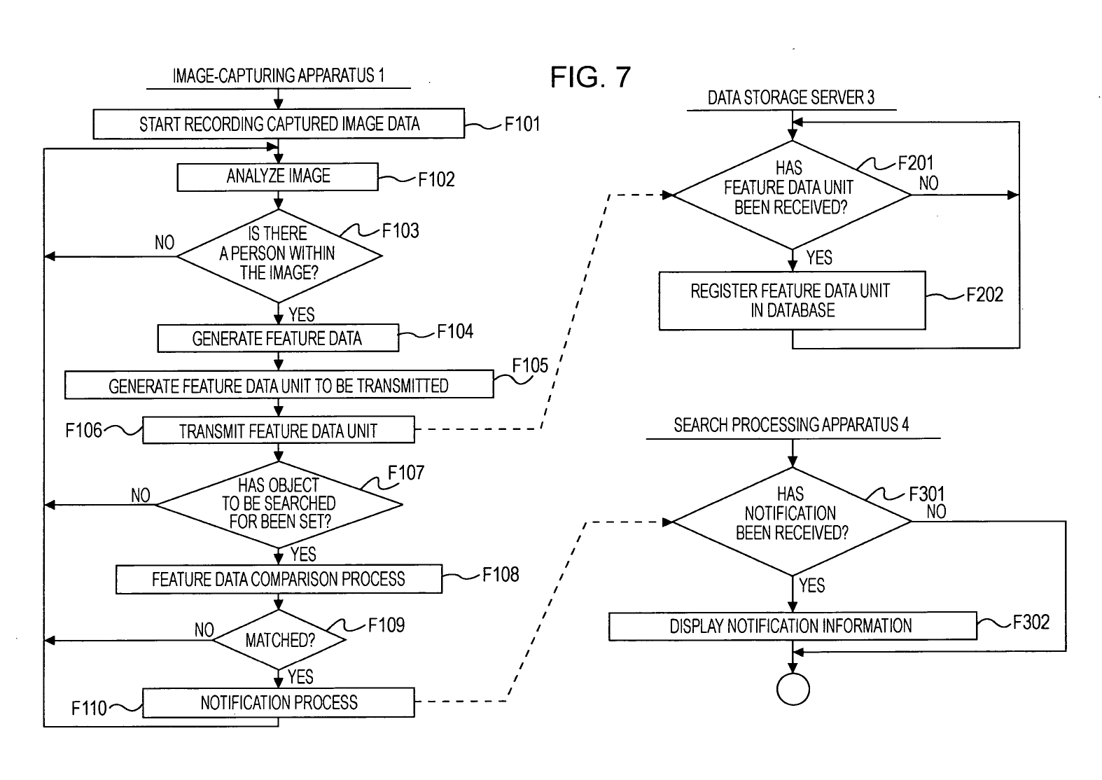

First, a description will be given, with reference to FIG. 7, of the operation until a feature data unit generated by the image-capturing apparatus 1 is registered in the feature data DB 43 by the data storage server 3.

In FIG. 7, steps F101 to F110 indicate processes of the image-capturing apparatus 1.

After the image-capturing apparatus 1 is installed at a predetermined place and is started up, the image-capturing apparatus 1 is assumed to continuously perform an image-capturing operation. Step F101 is a process when the image-capturing apparatus 1 starts operation. As a result of the controller 21 instructing the camera section 10, the recording and reproduction processor 23, and the HDD 24 to start operating, an image-capturing operation is hereinafter performed by the camera section 10, and captured image data is recorded in the HDD 24.

After the image capturing is started, the image-capturing apparatus 1 performs processing of step F102 and subsequent steps.

In step F102, image analysis is performed by the image analyzer 25. That is, with respect to the image data captured by the camera section 10, the image analyzer 25 performs a process for extracting an image portion of a person.

If it is determined in the image analysis process that no person is contained in the image data, the process returns from step F103 to step F102, and the process proceeds to an analysis process for the next image data.

The image analyzer 25 may perform an analysis process on the image data of all the frames for which a moving image has been captured by the camera section 10. Alternatively, by considering the processing performance and the processing time of the image analyzer 25, for example, image data of one frame may be extracted at intervals of predetermined frames, and an analysis process may be performed thereon. Furthermore, there is a case in which the image data that is recorded temporarily in the HDD 24 is read and supplied to the image analyzer 25, and image analysis is performed by the image analyzer 25.

When the image portion of the person is contained in the image data of a particular frame, the process proceeds from step F103 to step F104, and the image analyzer 25 analyzes the image portion of the person and generates feature data indicating the features of the person. For example, the features of the face are converted into a numeric value, data of the colors of the clothes is generated, and the estimated value of the height is computed. The generated feature data is transferred to the transmission data generator 26. When the image data is to be contained in the feature data unit as shown in FIG. 3A, the image data for which analysis has been performed is also transferred to the transmission data generator 26.

When the sensor 11 and the sense signal processor 29 are provided, the feature data obtained by the sense signal processor 29 in that case, for example, the body weight value, is also supplied to the transmission data generator 26.

In step F105, a feature data unit as shown in FIG. 3A or 3B is generated by the transmission data generator 26. Therefore, the controller 21 supplies the date and time information counted by the clock section 28 and the camera ID to the transmission data generator 26.

The transmission data generator 26 generates a feature data unit of FIG. 3A or 3B by using the supplied camera ID, date and time information, feature data, (and image data).

In step F106, the generated feature data unit is transmitted from the communication section 27 to the data storage server 3.

In step F107, the controller 21 confirms the presence or absence of the setting of a search object. Steps F107 to F110 and the processes (F301 and F302) of the search processing apparatus 4 will be described later.

When the search object has not been set, the process returns from step F107 to step F102, and the above processing of steps F102 to F106 is repeatedly performed.

As a result of this processing, when the person is photographed in the captured image data, the image-capturing apparatus 1 transmits the feature data unit containing the feature data of the person to the data storage server 3.

The processes of the data storage server 3 are shown as steps F201 and F202.

When the image-capturing apparatus 1 transmits the feature data unit to the data storage server 3 in the transmission process in step F106, the data storage server 3 performs a process for receiving the feature data unit. When the reception of the feature data unit is confirmed in step F201 by the reception process, the CPU 101 of the data storage server 3 proceeds to step F202, where a process for registering the received feature data unit in the feature data DB 43 is performed.

As a result of the above processing, one feature data unit is additionally registered in the feature data DB 43 shown in FIG. 6.

5. Person Search Using Feature Data

In the manner described above, in the feature data DB 43 of the data storage server 3, the feature data units with regard to the person image-captured by the image-capturing apparatuses 1 installed at various places are stored.

It is possible for the search processing apparatus 4 to search for a person by using the feature data DB 43. The search in this case refers to a search in which an operator specifies a plurality of places where image-capturing apparatuses 1 are fixedly installed and the time (time period) at each image-capturing apparatus 1 as search conditions, and image portions of persons as subjects who were present at the plurality of places are extracted. For example, it is a search in which an image portion of an unknown person is extracted as a person who has moved from place A to place B.

Such a search is suitable for deducing a person having a possibility of being a suspect when, for example, the escape route of a criminal of a particular incident is known.

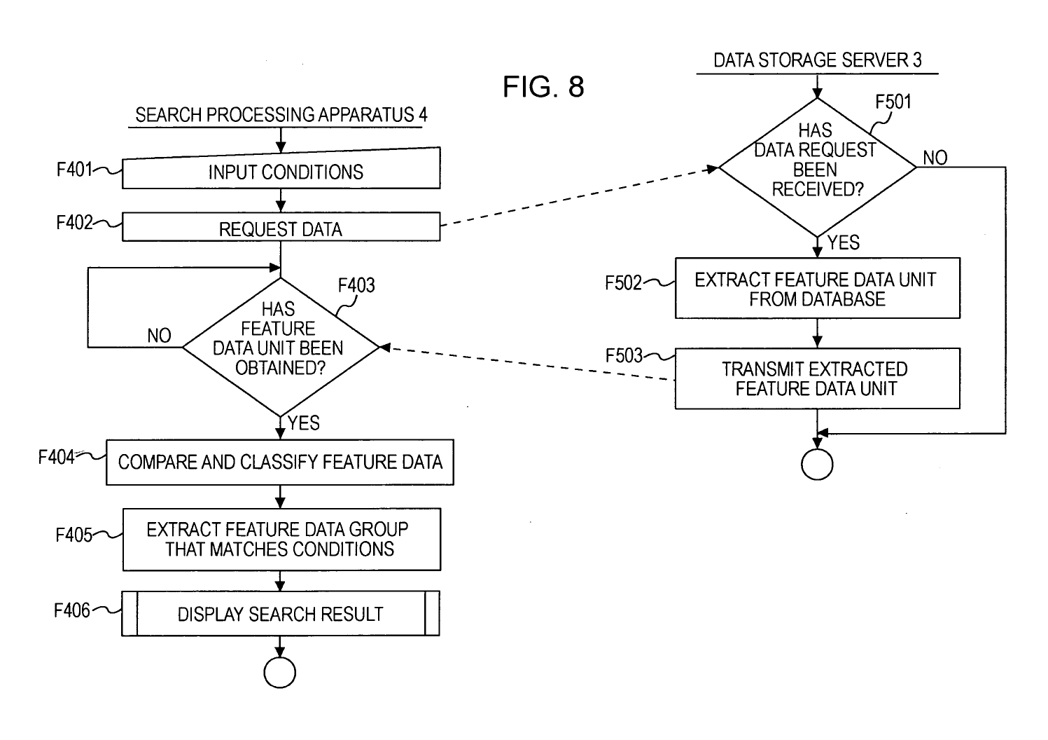

The operation of person search will be described below with reference to FIGS. 8 to 18.

FIG. 8 shows processes performed by the search processing apparatus 4 in steps F401 to F406 and processes performed by the data storage server 3 in steps F501 to F503.

The operator of the search processing apparatus 4 enters condition inputs for the purpose of a search in step F401. The search processing apparatus 4 accepts the condition inputs of the operator by means of the condition input function 31. In this case, a plurality of image-capturing apparatuses 1 and the time are specified as search conditions.

A description will be given below by using an example.

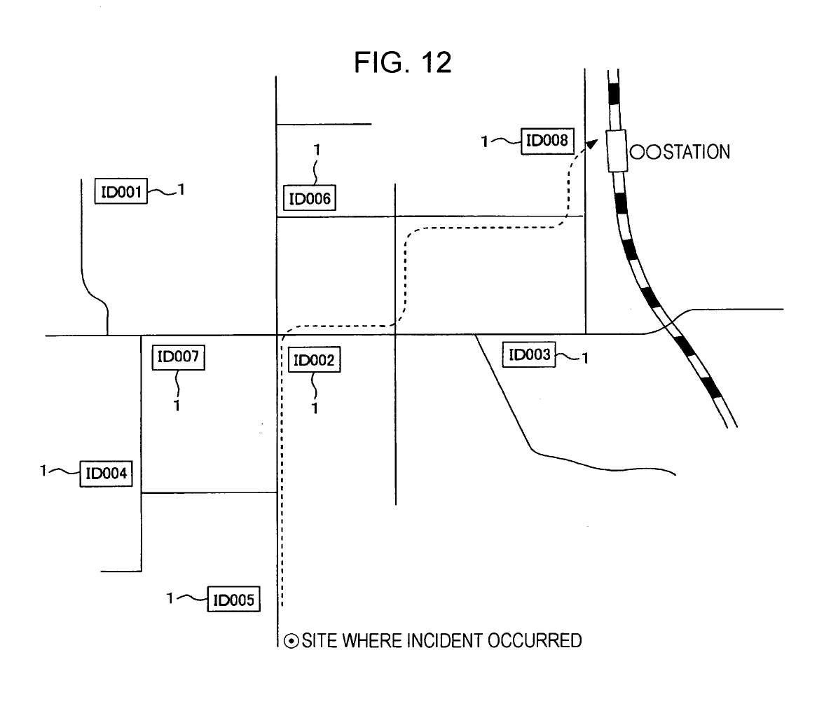

FIG. 12 shows a map of a particular town and the image-capturing apparatuses 1 installed in the town. The image-capturing apparatus 1 is installed at each place along streets, intersections, or the like. These image-capturing apparatuses 1 are assumed to be correspondingly provided with camera IDs “ID001” to “ID008”.

Here, it is assumed that a particular incident has occurred at the place ⊙ in FIG. 12 and that the police are investigating the incident. Then, a situation is assumed in which it is deduced that the criminal fled toward ◯◯ station along the path indicated by the dotted line from the site where the incident is believed to have occurred on the basis of the investigation, such as the collection of an eyewitness account of a suspicious character through interviewing and the finding of material evidence.

Then, it is deduced that the criminal has been image-captured by each of the image-capturing apparatuses 1 with “ID005”, “ID002”, and “ID008”.

It is also assumed that the date and time at which the incident occurred was around 10:00 on Jan. 5, 2006. In that case, it is deduced that the criminal has been image-captured at around 10:00 by the image-capturing apparatus 1 with “ID005”, image-captured at around 10:15 by the image-capturing apparatus 1 with “ID002”, and image-captured at around 10:20 by the image-capturing apparatus 1 with “ID008”.

In such a case, the operator that uses the search processing apparatus 4 specifies the image-capturing apparatuses 1 with “ID005”, “ID002”, and “ID008”, as condition inputs. The following is convenient from the viewpoint of ease of use in that a table in which camera IDs and installation places are associated with each other is prestored in the memory 102 or the HDD 109 so that the operator can specify each of the image-capturing apparatuses 1 by the name of the place and in that a map image indicating the installation places of the image-capturing apparatuses 1, shown in FIG. 12, is displayed so that the operator can specify the image-capturing apparatuses 1 on the map image.

Together with the specifying of the image-capturing apparatuses 1, the time is also specified. For example, conditions are input as “around 10:00 on Jan. 5, 2006” with respect to the image-capturing apparatus 1 with “ID005”, conditions are input as “around 10:15 on Jan. 5, 2006” with respect to the image-capturing apparatus 1 with “ID002”, and conditions are input as “around 10:20 on Jan. 5, 2006” with respect to the image-capturing apparatus 1 with “ID008”.

Of course, various time input methods are considered. For example, in addition to “around 10:00”, a time period may be input like “9:50 to 10:10”. When it is difficult to specify the time of an incident or the like, it is assumed that specification is made in units of days or a plurality of days are specified like January 4 to January 6. Furthermore, condition inputs are made by only the specification of the image-capturing apparatuses 1, and it can occur that the date and time is not specified.

A condition input of specifying the time-related sequence of image-capturing apparatuses 1 is possible without specifying a detailed time. For example, after only the date such as “Jan. 5, 2006” is specified, only the time-related sequence of image-capturing apparatuses 1 as “ID005”, “ID002”, and “ID008” are specified.

As is well known, as search conditions, in general, AND conditions and OR conditions are available. For the purpose of finding a criminal in the estimated escape route as shown in FIG. 12, AND conditions with regard to three image-capturing apparatuses 1 that are specified in the manner described above are specified.

When the search processing apparatus 4 accepts the above input conditions from the operator in step F401, the search processing apparatus 4 makes a request for data to the data storage server 3 on the basis of the condition input by using the feature data obtaining function 32 in step F402.

For example, a data request indicating each of the conditions of “ID005: around 10:00 on Jan. 5, 2006”, “ID002: around 10:15 on Jan. 5, 2006”, and “ID008: around 10:20 on Jan. 5, 2006” is transmitted to the data storage server 3.

In the data storage server 3, in response to such a data request, processes of steps F501 to F503 are performed by the feature data providing function 42.

That is, when a data request is received, the process proceeds from step F501 to step F502, where all the feature data units matching the conditions are extracted from the feature data DB 43. Then, in step F503, the read feature data unit is transmitted to the search processing apparatus 4.

The search processing apparatus 4 receives the feature data unit transmitted from the data storage server 3 by using the feature data obtaining function 32 and stores it in the HDD 109 or the memory 102.

Then, when obtaining of the feature data unit using the feature data obtaining function 32 is completed, the process proceeds from step F403 to step F404.

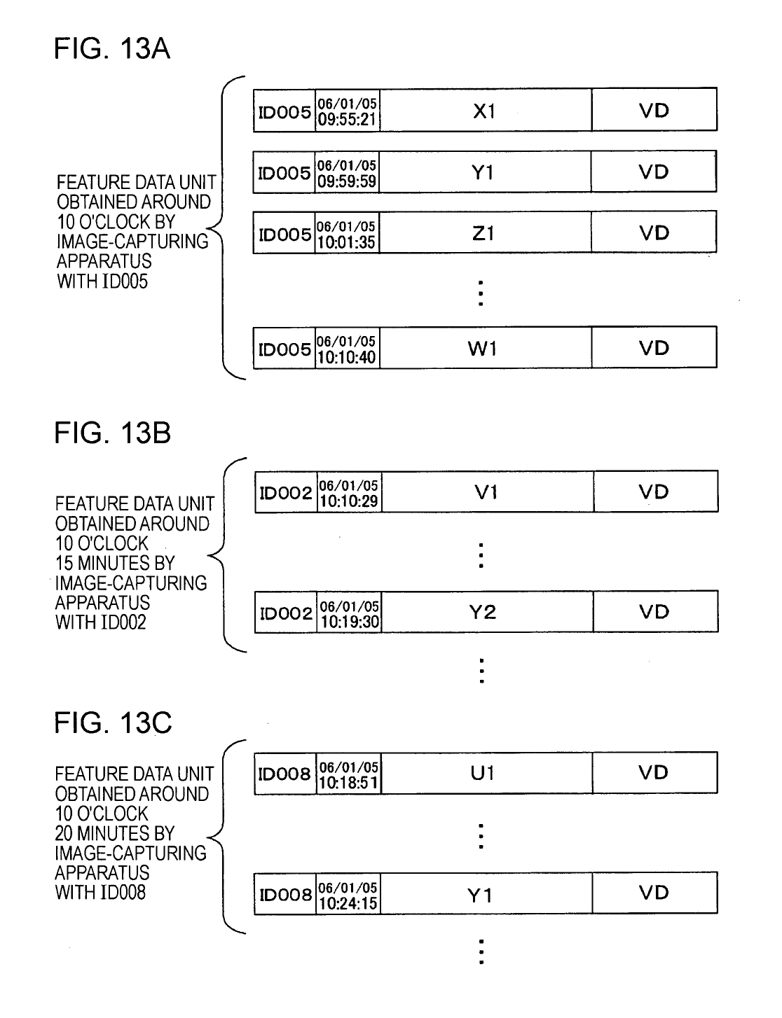

At this point in time, the search processing apparatus 4 has obtained the feature data units shown in FIG. 13 from the feature data DB 43.

That is, as shown in FIG. 13, many feature data units generated from the image data captured at around 10:00 on Jan. 5, 2006 by the image-capturing apparatus 1 with “ID005”, many feature data units generated from the image data captured at around 10:15 on Jan. 5, 2006 by the image-capturing apparatus 1 with “ID002”, and many feature data units generated from the image data captured at around 10:20 on Jan. 5, 2006 by the image-capturing apparatus 1 with “ID008” has been obtained.

Each feature data unit shown in FIG. 13 contains a camera ID such as “ID0051∞, date and time information of year/month/day/hour/minute/second such as “06/01/05 09:55:21”, feature data indicated by “X1” or the like, and image data VD. Needless to say, when the feature data unit has a structure of FIG. 3B, the image data VD is not contained.

For the convenience of description, the feature data in each feature data unit is shown by a combination of an alphabet and a numeral like “X1”, “Y1”, “Z1” . . . . Here, it is assumed that the feature data having a different alphabet is determined to be not same or similar. On the other hand, the same feature data is shown like “Y1” and “Y1”, and similar feature data is shown like “Y1” and “Y2”. That is, feature data determined to be the same or similar is shown using the same alphabet symbol.

For example, in FIG. 13, as feature data units with respect to the image-capturing apparatus of “ID005”, four feature data units are shown as an example. The feature data “X1”, “Y1”, “Z1”, and “W1” contained in the feature data units are determined to be the feature data of different persons.

Next, in the search processing apparatus 4, processes of steps F404 and F405 are performed by the classification and extraction function 33. This is a process for comparing the feature data of many feature data units obtained as shown in FIG. 13, determining whether or not they are the same, similar, or non-similar, and classifying them so as to be grouped. For example, “same” refers to feature data that has the same data value and that can be considered ad definitely being for the same person. “Similar” refers to feature data whose data values are close to each other and that has a possibility of being for the same person.

Examples of actual feature data and examples of similarity determination techniques will be described later.

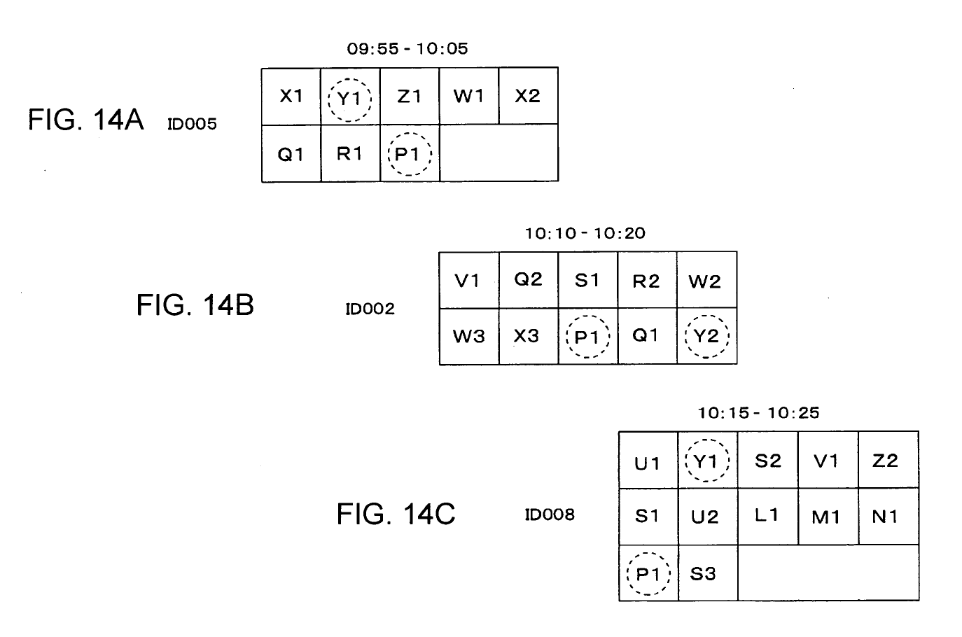

As feature data units obtained as shown in FIG. 13, it is assumed that there are eight feature data units with respect to the image-capturing apparatus 1 with “ID005”. Then, it is assumed that, as shown in FIG. 14A, the content of the feature data in each feature data unit is “X1”, “Y1”, “Z1”, “W1”, “X2”, “Q1”, “R1”, and “P1”.

It is also assumed that ten feature data units are obtained with respect to the image-capturing apparatus 1 with “ID002” and that, as shown in FIG. 14B, the content of the individual feature data is “V1”, “Q2”, “S1”, “R2”, “W2”, “W3”, “X3”, “P1”, “Q1”, and “Y2”.

It is also assumed that 12 feature data units are obtained with respect to the image-capturing apparatus 1 with “ID008” and that, as shown in FIG. 14C, the content of the individual feature data is “U1”, “Y1”, “S2”, “V1”, “Z2”, “S1”, “U2”, “L1”, “M1”, “N1”, “P1”, and “S3”.

The above are the results obtained as a result of performing similarity determination by comparing the pieces of feature data with one another.

For example, the results in the case of FIG. 14A show that there are similar feature data of “X1” and “X2”, and the others are determined to be non-similar. That is, in the image-capturing apparatus 1 with ID005, at least seven persons have been image-captured at the corresponding time period. The number of persons is seven if the persons who were subjects when the feature data of “X1” and “X2” was generated are the same, and is eight if the persons are different persons accidentally having very similar features.

When the feature data of each feature data unit is compared to perform similarity determination, next, common feature data is collected by each image-capturing apparatus 1 in order to group the feature data.

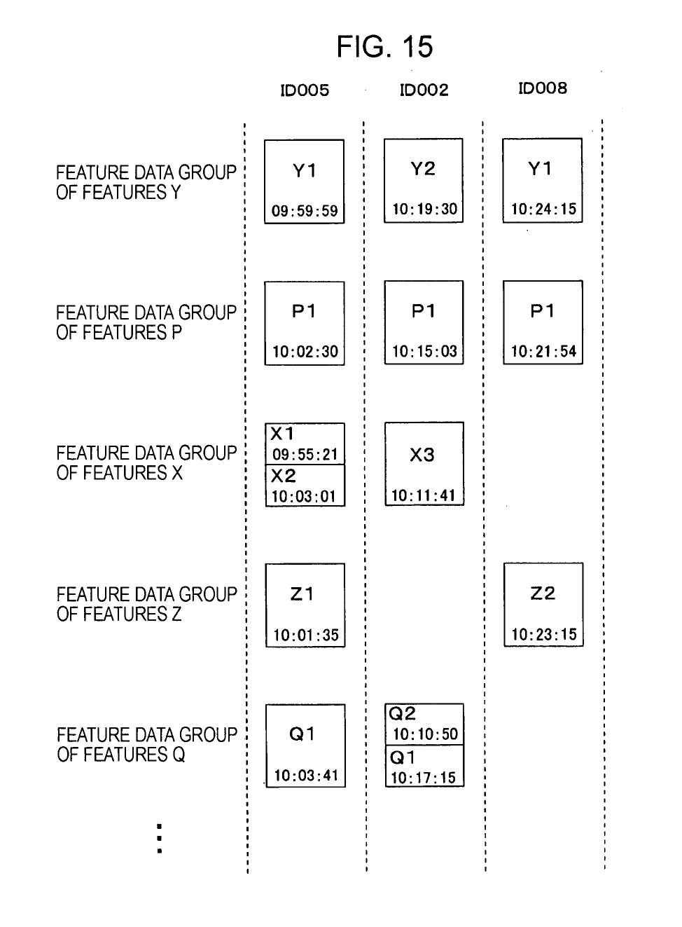

FIG. 15 shows the results of the grouping.

For example, three feature data units having common feature data as features Y are collected as a feature data group. That is, the feature data unit of feature data Y1 generated from the image data of 9:59:59 by the image-capturing apparatus 1 with “ID005”, the feature data unit of feature data Y2 generated from the image data of 10:19:30 seconds by the image-capturing apparatus 1 with “ID002”, and the feature data unit of feature data Y1 generated from the image data of 10:24:15 by the image-capturing apparatus 1 with “ID008,” are grouped.

Similarly, three feature data units having common feature data as features P are collected as a feature data group.

Furthermore, similarly, feature data units having common feature data as each of features X, features Z, features Q . . . are grouped.

In step F405, a feature data group corresponding to the purpose of a search is extracted from the feature data groups formed as groups as shown in FIG. 15.

In the case of a purpose of searching for a person whose escape route is deduced as shown in FIG. 12, since this involves finding a person image-captured by three image-capturing apparatuses 1 with “ID005”, “ID002”, and “ID008”, a feature data group corresponding to AND conditions with respect to the three image-capturing apparatuses 1 are extracted.

When they are grouped as shown in FIG. 15, the feature data groups of features Y and features P correspond to the AND conditions, and thus these are extracted as search results.

Here, since a search for a person who moved along the escape route of FIG. 12 is used as an example, AND conditions are used, but needless to say, this can be changed according to search purpose. Furthermore, since, for example, the person who moved along the escape route of FIG. 12 has not always been image-captured by the three image-capturing apparatuses 1, the AND conditions may be relaxed so that images of persons may be extracted as candidates even if the feature data group does not correspond to all the image-capturing apparatuses 1 like the feature data groups of features X and features Z.

Then, the search processing apparatus 4 performs a process for displaying the search results in step F406 by using the display processing function 34.

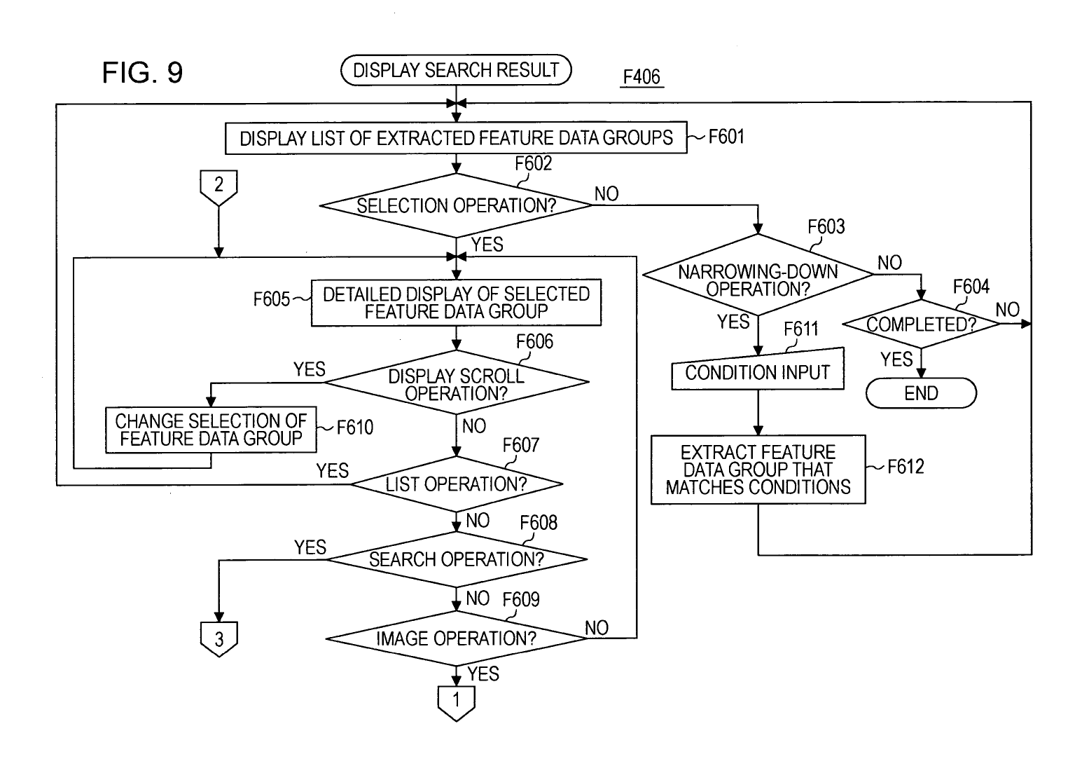

Various examples of processes for displaying search results can be considered, and an example will be described with reference to FIG. 9. FIG. 9 shows in detail the process of step F406 of FIG. 8. For the display process, the CPU 101 of the search processing apparatus 4 controls the display controller 104 so that the display process is performed by the display device 112.

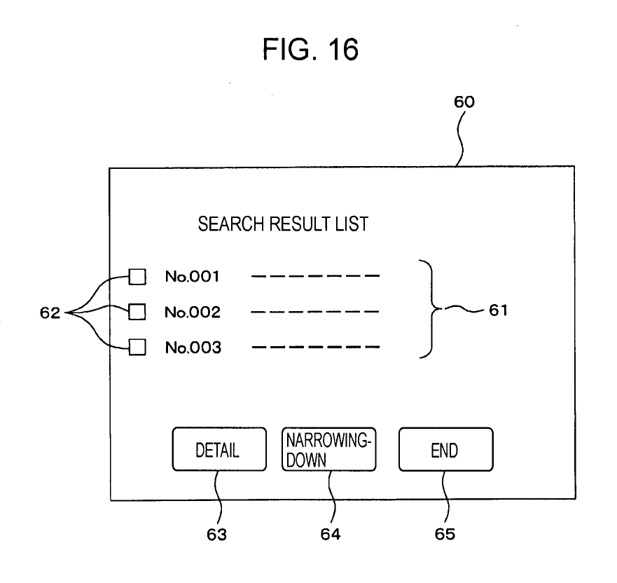

Initially, in step F601, the search processing apparatus 4 displays a list of the feature data groups extracted as search results. FIG. 16 shows an example of the display of a search result list 60.

Examples of the display content of the search result list 60 include a list display 61 of one or more feature data groups that are listed as search results, a check box 62 for selecting each feature data group, a detailed display instruction button 63, a narrowing-down button 64, and an end button 15.

It is possible for the operator that uses the search processing apparatus 4 to know the fact that one or more persons who are candidates of the person corresponding to the fleeing criminal have been found by viewing the search result list 60.

The operator can perform operations for making a request for a detailed display of each listed feature data group, for making a request for a narrowing-down search, or for ending the display.

The CPU 101 of the search processing apparatus 4 monitors a selection operation, a narrowing-down operation, and an ending operation as operations by the operator using the keyboard 107 or the mouse 108 in steps F602, F603, and F604, respectively.

When the end button 15 is clicked on, the CPU 101 ends the display process in step F604.

When the narrowing-down button 64 is clicked on, the CPU 101 proceeds from step F603 to step F611. For example, when the number of listed feature data groups becomes very large, the operator can narrow down on the basis of this operation.

In step F611, inputs of narrowing-down condition are accepted by using the condition input function 31. For example, when it is known that the person who is deemed as a criminal wore red clothes through an eyewitness account for a suspicious character, the condition of red clothes can be input as feature data.

When the condition input is made, the process proceeds to step F612, where the feature data groups are narrowed down by using the classification and extraction function 33 according to the input conditions. The process then returns to step F601, where feature data groups that are extracted by narrowing-down are displayed as a list.

Next, a description will be given of a case in which a detailed display of listed feature data groups is performed.

When the operator performs a predetermined operation for selecting a particular feature data group and for making a request for a detailed display, such as clicking on the detailed button 63 by performing an operation of checking one of the check boxes 62, or clicking or double-clicking the listed feature data group itself, the search processing apparatus 4 (CPU 101) proceeds from step F602 to step F605, where a detailed display of the feature data groups selected from the list is performed.

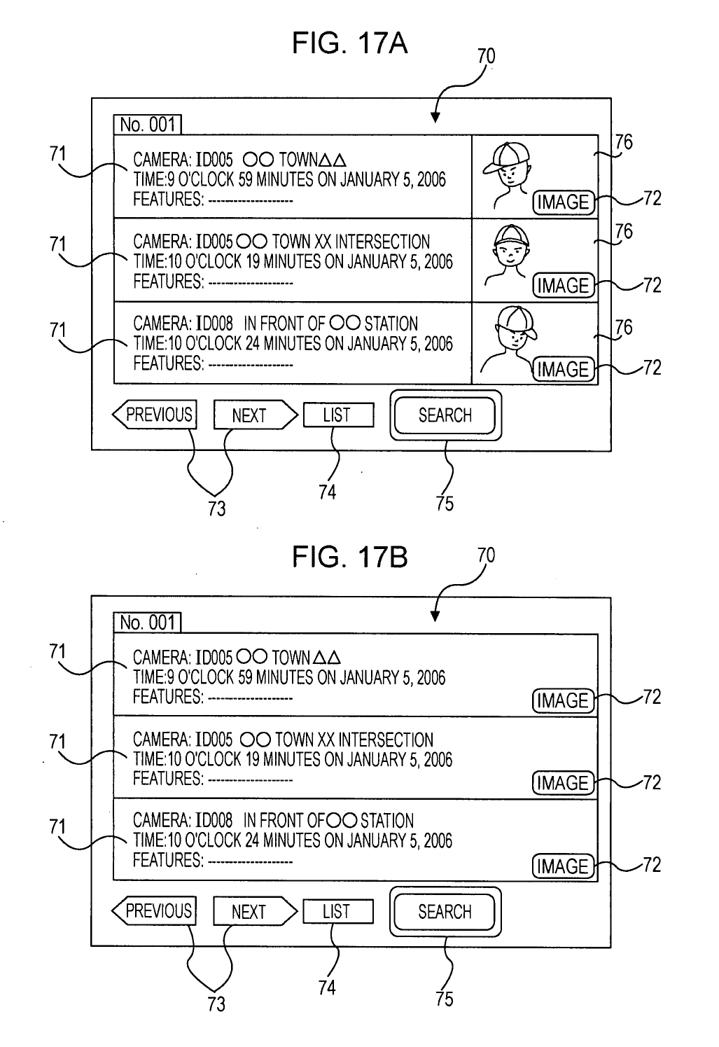

FIGS. 17A and 17B show examples of detailed displays. FIG. 17A shows an example of a detailed display when image data is contained in feature data units, as shown in FIG. 3A. FIG. 17B shows an example of a detailed display when image data is not contained in feature data units, as shown in FIG. 3B.

It is assumed that the selected feature data group is a feature data group of features Y of FIG. 15. For the detailed display of this feature data group, as shown in FIGS. 17A and 17B, the content of three feature data units contained in the feature data group of the features Y is displayed.

As a detailed display 70 on the screen, the contents of three feature data units are displayed as feature data unit content 71. That is, the content of a camera ID, the installation place of the camera ID, the image-capturing time, and the feature data is displayed. An image 76 of the image data contained in the feature data unit is also displayed. When the structure of the feature data unit is as shown in FIG. 3B, no image is displayed with regard to each feature data unit, as shown in FIG. 17B.

Also, an image button 72 with regard to each feature data unit is displayed.

Furthermore, display scroll buttons 73 of “Previous” and “Next” for shifting to a detailed display of another feature data group, a list button 74 for returning to the display of the search result list 60 of FIG. 16, and a search button 75 are displayed.

Since a detailed display is performed as shown in FIG. 17A or 17B, it is possible for the operator to view detailed information on one person among the persons who moved along the path indicated by the dotted line of FIG. 12. In the case of FIG. 17A, the image portion of the photographed person can also be confirmed.

As a click operation for this screen, the operator can operate the display scroll buttons 73, the list button 74, the search button 75, and the image button 72. The CPU 101 of the search processing apparatus 4 monitors the click operation of these buttons in the steps F606, F607, F608, and F609, respectively.

When one of display scroll buttons 73 is operated, the process proceeds from step F606 to step F610, where, as a change of the selection of the feature data group, the selection is changed to a feature data group before or after that in the list, and in step F605, a detailed display of the newly selected feature data group is performed. For example, if the display scroll button 73 of “Next” is operated when a detailed display of the feature data group of features Y is to be performed, the CPU 101 performs control so that the display is changed to the detailed display of the feature data group of features P.

When the list button 74 is operated, the process returns from step F607 to step F601, where the CPU 101 performs control so that the display is returned to the display of the search result list 60 shown in FIG. 16.

When the detailed display 70 shown in FIG. 17B is viewed, it is possible for the operator to view the actually captured image with regard to the displayed feature data unit. Also, when the image 76 is displayed as shown in FIG. 17A, a more detailed image that is actually captured can be viewed.

When it is desired to view a captured image with regard to the feature data unit, the operator needs only to click on the image button 72 for the feature data unit.

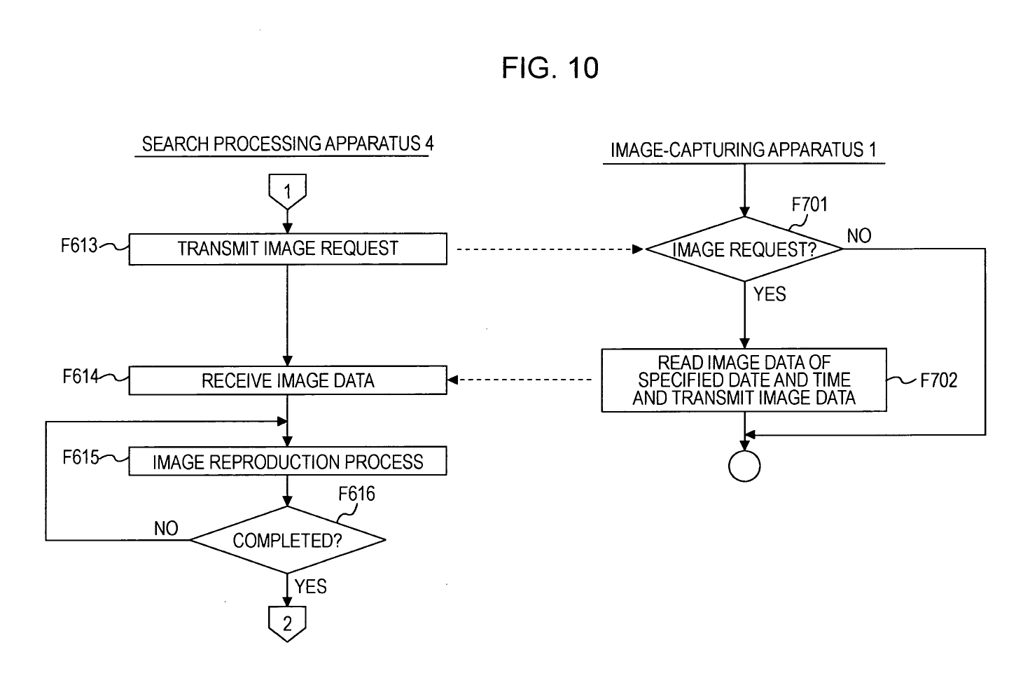

In this case, by assuming that an operation for making a request for an image has been performed, the CPU 101 of the search processing apparatus 4 proceeds from step F601 to step F613 of FIG. 10, where processing using the image request function 35 is performed. That is, in step F613, the CPU 101 transmits a request for an image for a specific image-capturing apparatus 1 in such a manner that the image request operation corresponds to the feature data unit.

For example, when the user clicks on the image button 72 with respect to the feature data unit of the camera ID “ID005”, the CPU 101 performs a process for transmitting an image request to the image-capturing apparatus 1 with “ID005” via the communication section 103.

Furthermore, the image request is assumed to contain identification information of the search processing apparatus 4 that is the transmission source, and date and time information of the target feature data unit such as “9 hours 59 minutes 59 seconds 15 frames on Jan. 5, 2006”. Alternatively, a time period before and after this date and time information may be specified. For example, information indicating a time period like “19:55 to 10:05 on Jan. 5, 2006”, may be used.

For example, when the image request from the search processing apparatus 4 is received, the image-capturing apparatus 1 with “ID005” proceeds from step F701 to step F702, where a process is performed for reading the image data of the specified date and time from the HDD 24 and for transmitting it to the search processing apparatus 4.

That is, the controller 21 of the image-capturing apparatus 1 confirms the date and time information contained in the image request and allows the HDD 24 and the recording and reproduction processor 23 to reproduce the image corresponding to the date and time information. Then, the controller 21 allows the transmission data generator 26 to perform a predetermined encoding process for transmission on the reproduced image data and to transmit it from the communication section 27 to the search processing apparatus 4.

In this case, various image data to be reproduced from the HDD 24 can be considered. If the date and time information contained in the image request is a particular time, a time period before and after the particular time is automatically determined as, for example, ±5 minutes, so that image data may be reproduced as a moving image for the 10 minutes and may be transmitted to the search processing apparatus 4. Alternatively, for example, a still image of one frame at that time or a still image of a plurality of frames extracted before and after the time, may be reproduced and may be transmitted to the search processing apparatus 4.

Furthermore, if a time period is specified as date and time information contained in the image request, image data may be reproduced as a moving image in the time period and may be transmitted to the search processing apparatus 4. Alternatively, for example, a still image of a plurality of frames contained in the time period may be extracted and may be transmitted to the search processing apparatus 4.

On the search processing apparatus 4 side, in step F614, image data that is transmitted from the image-capturing apparatus 1 in this manner is received. For example, the CPU 101 causes the received image data to be stored in the HDD 109 or the memory 102.

Then, when the reception of the image data transmitted from the image-capturing apparatus 1 is completed, the search processing apparatus 4 performs an image reproduction process in step F615.

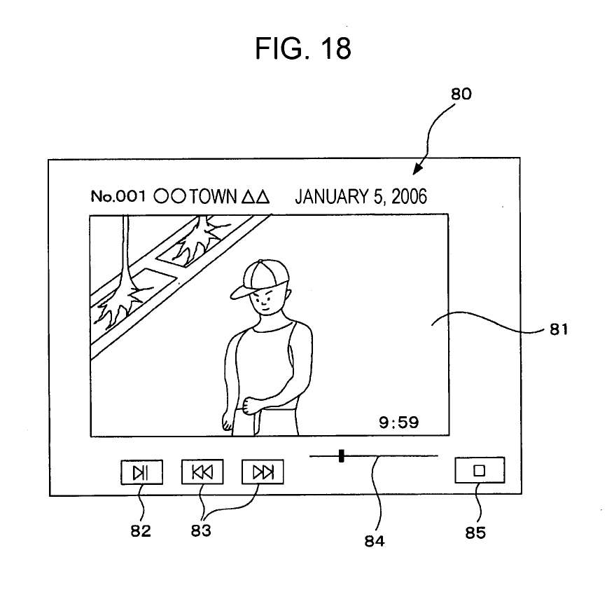

For example, a reproduction screen 80 shown in FIG. 18 is displayed. For example, when image data as a moving image of a predetermined time period is to be transmitted, on the reproduction screen 80, as shown in FIG. 18, an image 81, a play/pause button 82, a search button 83, a progress bar 84, and a stop button 85 are displayed, so that a captured image of the target time period is reproduced as the image 81 on the basis of the operation of the operator.

For example, it is possible for the operator to view an image captured by, for example, the image-capturing apparatus 1 with “ID005” by clicking on the play/pause button 82. That is, an actually captured image when the feature data unit associated with the image request for this time can be confirmed. As a result, it is possible to actually view the appearance of the person corresponding to the feature data in the feature data unit and further the behavior thereof.

When the operator clicks on the end button 85, the CPU 101 proceeds from step F616 of FIG. 10 to step F605 of FIG. 9, where the display is returned to the original detailed display 70 of FIG. 17A or 17B.

Since the image button 72 is provided with respect to each feature data unit on the detailed display 70, by clicking on each image button 72, processing of FIG. 10 is performed, and an actual image when each feature data unit is generated by each corresponding image-capturing apparatus 1 can be viewed.

As shown in FIGS. 17A and 17B, on the screen, the search button 75 is provided for a feature data group. In the list 60 of FIG. 16, a search button may be provided for each feature data group.

In the search system according to this embodiment, by operating the search button 75, it is possible to perform a process for searching for the current whereabouts of, for example, a suspect.

For example, it is assumed that the operator (police staff or the like) who has viewed details of the feature data groups as search results or a captured image in the manner described above considers a person found as being contained in a particular feature data group to be a suspect or a material witness and wants to find the person.

In such a case, when it is desired to search for the person of the feature data group by using the image-capturing apparatuses 1 installed at each place, the search button 75 provided for the feature data group needs only to be operated.

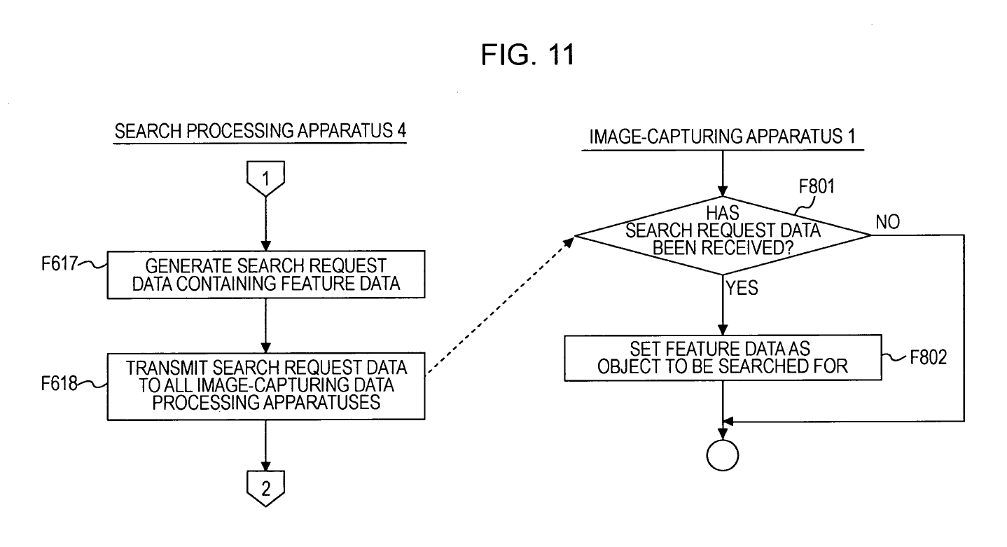

When the operator clicks on the search button 75, the CPU 101 of the search processing apparatus 4 proceeds from step F608 of FIG. 9 to step F617 of FIG. 11, where processing using the search request function 36 is performed.

In step F617, the CPU 101 generates search request data containing the feature data for the feature data group for which the search request operation has been performed. If each feature data unit contained in the feature data group has the same feature data, the feature data may be contained, and if each feature data unit has similar feature data, a numerical value of the feature data may have a certain degree of width.

Since search request data is used for each image-capturing apparatus 1 to search for a person corresponding to feature data from the current time onward, the feature data contained in the search request data is made to be feature data suitable for a search. That is, feature data that does not change even as time passes is preferable, for example, the feature data of a face is used. On the other hand, the color of clothes is preferably excluded from the feature data contained in the search request data because the person as the object of the search does not always wear the same clothes.

When the search request data is generated, in step F618, the CPU 101 allows each image-capturing apparatus 1 to transmit search request data from the communication section 103.

Image-capturing apparatuses 1 as transmission sources are assumed to be all the image-capturing apparatuses 1 in the search system. However, for example, the operator may select the transmission destination so that one or more image-capturing apparatuses 1 installed at a specific area are set as transmission sources.

After the search request data is transmitted, the process returns to step F605 of FIG. 9.

On each image-capturing apparatus 1 side, when the search request data is received, the controller 21 proceeds from step F801 to step F802, where the feature data contained in the search request data is set as a search object. For example, an area for registering the feature data for which a search object is to be set is provided in the memory 22, and the feature data is registered in the registration area.

After such a setting of the search object is performed, in each image-capturing apparatus 1, processes of steps F108 to F110 of FIG. 7 are performed during the normal operation.

More specifically, in the image-capturing apparatus 1, operations for generating feature data with respect to the captured image data while performing image capturing as described above and sending a feature data unit to the data storage server 3 are repeated. When a search object has been set, the controller 21 proceeds from step F107 to step F108. Then, the controller 21 performs a process for comparing the feature data generated in step F104 with the feature data for which a search object has been set to determine whether or not the contents of the feature data are same, similar, or non-similar.

When they are non-similar, the process returns from step F109 to step F102, and when they are determined to be same or similar, a notification process is performed in step F110. That is, the controller 21 allows the transmission data generator 26 to generate notification information that a person having common feature data has been image-captured with respect to one piece of feature data for which a search object has been set. The content of the notification information should preferably be information containing a camera ID, date and time information, feature data content, image data, or the like similarly to the feature data unit of FIG. 3. Then, the controller 21 allows the notification information to be transmitted from the communication section 27 to the search processing apparatus 4.

In response to the reception of the notification information, the CPU 101 of the search processing apparatus 4 proceeds from step F301 to step F302, where the content of the notification information is displayed on the display device 112. For example, the image-capturing places, the captured images, the feature data content, and the date and time that can be determined from the camera ID are displayed.

As a result of performing such operations, when a person for which a search has been performed is captured by a particular image-capturing apparatus 1, the fact can be known on the search processing apparatus 4 side. That is, when, for example, the whereabouts of a suspect, a material witness, or the like are not known, the current whereabouts can be searched for. If the person is the target person by confirming the content of the notification information, it is possible to, for example, dispatch an investigator to the vicinity of the image-capturing apparatus 1.

With respect to the content of the feature data group that has been set as a search request object by each image-capturing apparatus 1 in the process of FIG. 11, preferably, the content of the feature data group can be displayed as a list of investigations in operation on the search processing apparatus 4 side. Also, with respect to the feature data group that becomes unnecessary because the incident has been solved, preferably, a setting cancel is transmitted to each image-capturing apparatus 1. On the search processing apparatus 4 side that has received the information on the setting cancel, the corresponding feature data should preferably be deleted from the registration of the search objects.

6. Feature Data and Determination as to Similarity thereof

In the search system according to this embodiment that performs the above-described operations, a person is searched for and investigations are performed on the basis of feature data.

The feature data is data used to identify a person, and specific examples thereof include face data, height data, weight data, and cloth data. The face data, the height data, and the clothes data can be obtained by analyzing image data captured by the image analyzer 25.

As one of the most appropriate pieces of data for the purpose of identifying a person, face data is cited.

Various kinds of face data can be considered, and as an example, there is relative position information of components of a face.

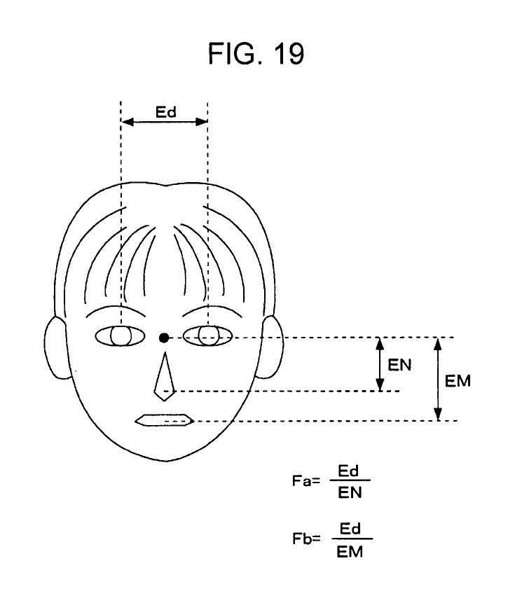

For example, as shown in FIG. 19, the ratio of the distance EN between the center of the eye and the nose to the distance Ed of the interval of the eyes (the center of the eye) is denoted as Fa. For example, Fa=Ed/EN.

The ratio of the distance EM between the center of the eye and the mouth to the distance Ed of the intervals of the eyes is denoted as Fb. For example, Fb=Ed/EM. As the face data, such values Fa and Fb can be adopted.

Such relative position information of components of a face becomes specific to each individual and is information that is not influenced by changes in appearance due to the hair style, and fittings such as eyeglasses. It is also known that the relative position information does not change due to aging.

Therefore, the relative position information is feature data suitable for determining whether the persons captured by a plurality of image-capturing apparatuses 1 are the same person or different persons.

Furthermore, by using the height data, the cloth data, the weight data, and the like together with the face data, the accuracy of the determination as to the same person can be improved.

The height data can be calculated on the basis of the position of the image-captured person, and the upper end of the head part or the height of the eye or the like. By considering that the image-capturing apparatus 1 is fixedly installed, and the image-capturing direction of the camera section 10 and the distance to the subject are fixed, the estimated calculation of the height is comparatively easy. For example, in an image-capturing apparatus 1 that captures the image of a person who passes along the ticket gates of a station, the height of the wicket gates is prestored as a reference. Then, by performing calculations in the captured image data by using the height of the wicket gates in the image as a reference, the height of the head part position of the person who passes, that is, height, can be computed.

The clothes data can be easily determined from the image data by particularly using the information on the colors of the clothes. That is, the degree of saturation of an RGB signal as an R (red) value, a G (green) value, and a B (blue) value of the cloth portion in the image data needs only to be detected to generate color information.

Since it is difficult to detect the weight data from the image, a weight measuring device is used as the sensor 11. For example, in the case of the image-capturing apparatus 1 installed at the ticket gates of a station, by incorporating a pressure sensor as the sensor 11 on the floor of the wicket gates, the person who passed the ticket gates, that is, the image-captured person, can be detected.

For example, by generating feature data using only the face data or using the height data, the clothes data, the weight data, and the like in combination with the face data, feature data suitable for identifying a person can be generated.

Of course, in addition to the above, there are a large number of pieces of information that can be used as feature data. A metal detector may be provided as the sensor 11 so that information on the metal reaction thereof is contained in the feature data. Furthermore, as information that can be detected from the image, presence or absence of wearing of eyeglasses, presence or absence of a hat, features of a beard/mustache, and the like may be used as auxiliary information for identifying a person.

The feature data generated by each image-capturing apparatus 1 does not always become the same data value even for the same person. Some variations occur due to, for example, the image-capturing angle, the passage of time, measurement errors, and the like.

Therefore, for example, in step F404 of FIG. 8 or in step F108 of FIG. 7, when comparing the feature data, a certain degree of a numerical value width is provided, so that, if within it, the feature data is determined to be similar. That is, a range in which the feature data is deduced to be for the same person is provided. For example, if the values of the above-described Fa and Fb as the face data, the height, the weight, and the like are within a deviation of, for example, ±5% among the feature data to be compared with, the feature data is determined to be similar, and the possibility of being the same person is determined to be high.

7. Example of Specification of Image-Capturing Apparatus in Search

In the description provided as the operation of the search system according to this embodiment, an example is described in which, when the escape route indicated by the dotted line of FIG. 12 is deduced, a search is performed by specifying three image-capturing apparatuses 1 as the image-capturing apparatuses 1 having the possibility of image-capturing the criminal. That is, it is an example in which a search is performed by specifying individual image-capturing apparatuses 1. However, in the search system according to this embodiment, in addition to individually specifying a plurality of image-capturing apparatuses 1, a specifying technique at a search time is considered.

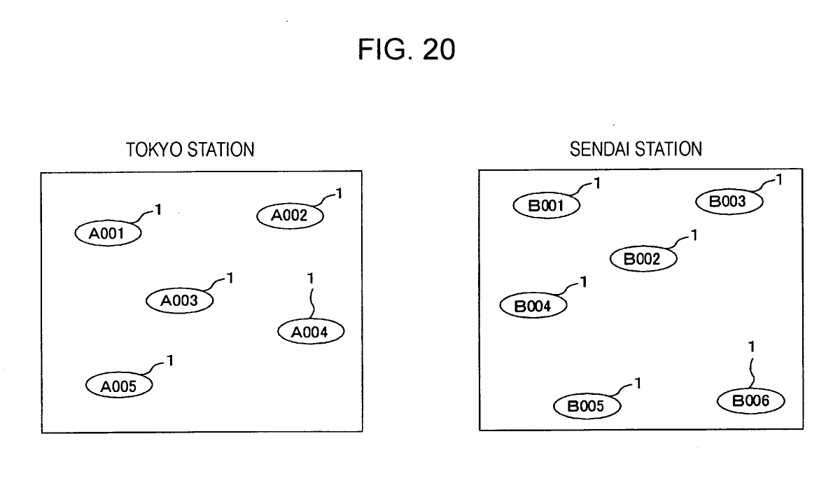

FIG. 20 shows a state in which image-capturing apparatuses 1 having camera IDs “A001” to “A005” are arranged at each place in the premises of Tokyo station and image-capturing apparatuses 1 having camera IDs “B001” to “B006” are arranged at each place in the premises of Sendai station. For example, when it is desired to make a list of persons who moved from Tokyo station to Sendai station, a specification method is considered in which a plurality of image-capturing apparatuses 1 having a camera ID ” A***” are specified as “the image-capturing apparatuses 1 at Tokyo station” and a plurality of image-capturing apparatuses 1 having a camera ID “B***” are specified as “the image-capturing apparatuses 1 at Sendai station”. That is, this is a method in which the image-capturing apparatuses 1 are specified in units of a group of image-capturing apparatuses 1.

When a suspect of a particular incident has moved in a bullet train from Tokyo station at 15 o'clock to Sendai, the target person can be found by specifying the image-capturing apparatus at Tokyo station at around 5 o'clock and the image-capturing apparatus at Sendai station at around 17 o'clock, which is approximately 2 hours later, and by performing a comparison and classification process on the feature data unit in that case. It becomes possible to make a list of persons who have moved between Tokyo and Sendai as the persons image-captured by the image-capturing apparatuses 1 with, for example, “A002” and “B003”, as the persons image-captured by the image-capturing apparatuses 1 with, for example, “A005” and “B001” . . . , and to confirm the details of the features and the images. Furthermore, only the date is specified without specifying the time and the time period in a detailed manner, and “the image-capturing apparatuses 1 at Tokyo station” and “the image-capturing apparatuses 1 at Sendai station” are specified as the time-related sequence, thereby making it possible to search for a person who has moved from Tokyo to Sendai on the target day.

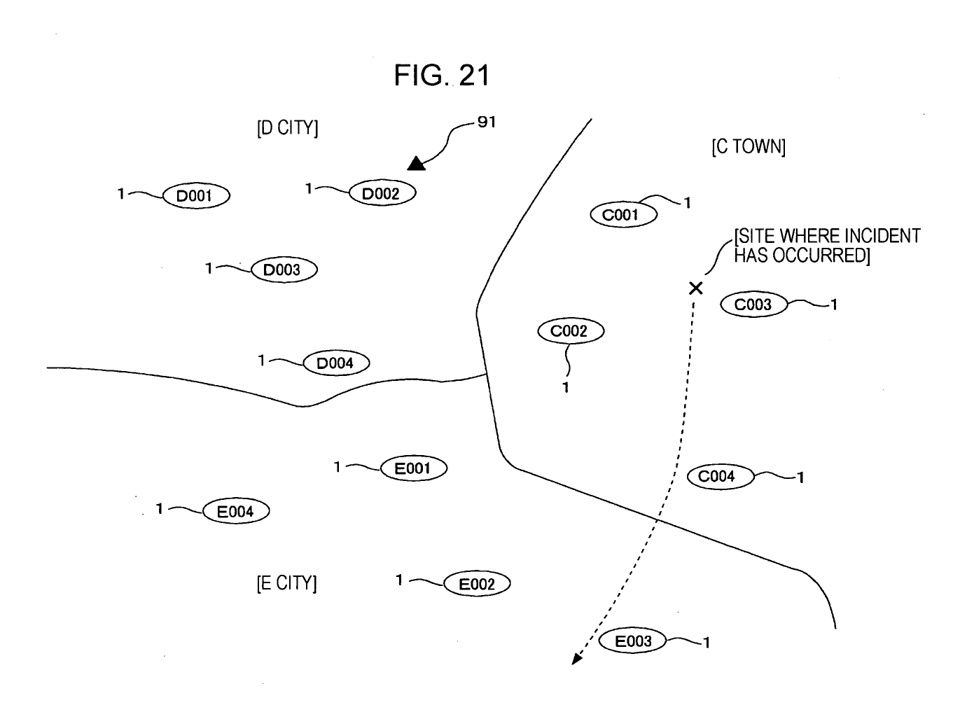

FIG. 21 shows image-capturing apparatuses 1 installed at each place in C town, D city, and E city. In C town, image-capturing apparatuses 1 having camera IDs “C001” to “C004” are arranged at each place. In D city, image-capturing apparatuses 1 having camera IDs of “D001” to “D004” are arranged at each place. In E city, image-capturing apparatuses 1 having camera IDs of “E001” to “E004” are arranged at each place.

For example, it is assumed that a particular incident has occurred at place A indicated by ..x.. in C town and that the possibility that the criminal has been image-captured by the image-capturing apparatus 1 with “C003” is high.

In this case, the image-capturing apparatus 1 with “C003”, and the image-capturing apparatuses 1 other than that apparatus in C town and all the image-capturing apparatuses 1 in D city adjacent to C town and those in E city are specified and a search process is performed, so that the images of persons who are deemed to be the same person who has been image-captured by the image-capturing apparatus 1 with “C003” and the image-capturing apparatuses 1 other than that apparatus are extracted. At this time, if the person who is deemed to have features common to those of the person who was photographed by the image-capturing apparatus 1 with “C003” has been image-captured by “C004” and “E003”, it becomes possible to deduce the features of the criminal and the escape route indicated by the dotted line.

Alternatively, it is also possible to confirm along which path each of many persons who were photographed by the image-capturing apparatus 1 with “C003” before and after the time at which the incident has occurred moved, and therefore, it is possible to deduce a suspect among the many persons.

For making a search in the manner described above, one image-capturing apparatus 1 with, for example, “C003” and a large number of image-capturing apparatuses 1 in the vicinity of thereof can be specified so that images of persons can be classified and extracted by the comparison of the feature data.

Furthermore, when a child who has become lost is protected at a place 91 indicated by ▴ at which the child has been image-captured by the image-capturing apparatus 1 with “D002”, a search is performed by specifying the image-capturing apparatus 1 with “D002” and all the other image-capturing apparatuses 1, and a list of persons having common feature data is made. Thereafter, by examining the content of the feature data group corresponding to the protected child, it is also possible to confirm along which path the child has moved.

8. Data Storage in Image-Capturing Apparatus

As described above, in the image-capturing apparatus 1, image data that is captured by continuously performing image capturing is recorded in the HDD 24. However, as captured image data is continuously recorded, the burden on the recording capacity of the HDD 24 is large. On the other hand, when it is considered that the image data is used for investigations by the police as described above, preferably, image data with image quality as high as possible is stored, and high-precision image data can be provided to the search processing apparatus 4 when an image request occurs.

Therefore, in the image-capturing apparatus 1, image data is recorded at comparatively high precision quality in the HDD 24 during image capturing, and after some days have passed, a process for reducing the amount of data is performed.

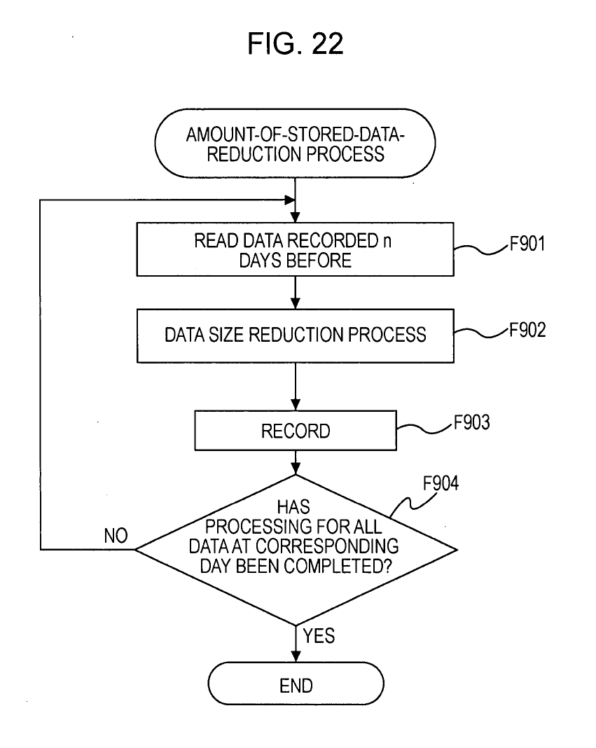

FIG. 22 shows an amount-of-stored-data-reduction process performed by the controller 21 of the image-capturing apparatus 1. The controller 21 performs this process, for example, once every day in order to reduce the amount of the image data for which a predetermined period of time has passed.

Initially, in step F901, the controller 21 reads data recorded n days before from within the image data recorded in the HDD 24. For example, when it is assumed that the amount of data is to be reduced with respect to the image data for which one week has passed from when the data was recorded, the controller 21 reads the image data 7 days before in step F901.

In step F901, the controller 21 allows the HDD 24 and the recording and reproduction processor 23 to read a predetermined amount of data as processing units from within the image data for 24 hours of n days before and allows them to temporarily store the read image data in a buffer memory in the recording and reproduction processor 23.

Then, in step F902, the controller 21 allows the recording and reproduction processor 23 to perform a data-size-reduction process on the received image data. For example, a re-compression process is performed on the read image data at a higher compression ratio.

In step F903, the re-compressed image data is supplied to the HDD 24 again, whereby it is recorded.

The above-described processes are performed for each predetermined amount of data until it is determined in step F904 that re-compression for the image data for one day has been completed.

As a result of performing this processing, image data for which n days have passed is reduced in its size, and image data as long a period of time as possible as a whole can be stored in the HDD 24.

As a technique for reducing the amount of data, re-compression is performed with the compression ratio set to be higher and also, the number of frames may be reduced by thinning out frames in the case of a moving image. For example, one frame for each second may be extracted so as to be formed as still-image data at intervals of one second. Alternatively, reduction in the number of frames and compression at a high compression ratio may be combined.

At the time of image capturing, image data is recorded as a moving image. Alternatively, a still image may be recorded at intervals of one second at the time of image capturing. In this case, as an amount-of-data-reduction process, a technique can be conceived in which only still image data at intervals of five seconds is stored and the other data is discarded.

Furthermore, another technique can be conceived in which information as to whether or not a person has been photographed in the image is recorded as an analysis result of the image analyzer 25, the analysis being performed at the time of image capturing, and image data in the period during which no person has been photographed is discarded.

Furthermore, the amount-of-stored-data-reduction process may be performed at several stages rather than only once. The amount of data is gradually decreased with the passage of the time period by, for example, performing a first amount-of-data reduction after an elapse of three days and performing a second amount-of-data reduction after an elapse of one week.

9. Advantages of Embodiments, and Modifications

According to the search system according to the above-described embodiment, a large number of image-capturing apparatuses 1 are fixedly installed at different places, image data captured by continuously performing image capturing is recorded, and feature data of a person or the like contained in the captured image data is generated. Then, a feature data unit containing feature data, camera ID, date and time information, and (and image data) is generated, and this feature data unit is transmitted to the data storage server 3.

In the data storage server 3, the feature data unit from each image-capturing apparatus 1 is stored in the feature data DB 43. Therefore, in the feature data DB 43, the feature data of persons image-captured by the image-capturing apparatuses 1 at various places is stored.

Then, it is possible for the search processing apparatus 4 to perform a search so as to make a list of persons or the like corresponding to the conditions from the feature data DB 43.

In particular, according to the search system of the embodiment, by specifying a plurality of places at which a plurality of image-capturing apparatuses 1 are fixedly installed, it is possible to extract images of persons as a subject who were present at the plurality of areas. That is, a search for finding an unknown person image who was present at plural areas becomes possible. As a result, it is possible to perform an effective search in, for example, a criminal investigation.

Furthermore, since date and time information is contained in the feature data unit and date and time with regard to each image-capturing apparatus 1 can be specified as search conditions in the search processing apparatus 4, a more appropriate search becomes possible.

Furthermore, since image data is contained in the feature data unit, it is possible to display the image 76 as a search result display as shown in FIG. 17A, and confirmation of a person using an image is made easier. On the other hand, if image data is not contained in the feature data unit, communication burden on the network 90 and capacity burden on the feature data DB 43 can be reduced.

Furthermore, in both cases, in the search processing apparatus 4, in response to an image request for the image-capturing apparatus 1, images stored in the HDD 24 can be obtained and displayed in the image-capturing apparatus 1. As a result, it is possible for police staff or the like to confirm actually captured images and to examine the corresponding person. Furthermore, since image data from the HDD 24, for example, moving image data, is transmitted to the search processing apparatus 4 only when the image data is necessary as a search result, the number of chances of communicating the image data does not become indiscriminately large. This is also suitable for the reduction in processing burden on the image-capturing apparatus 1 and in loads of network communication and for realization of smooth operation due to the reduction.

Performing a search of detecting a person corresponding to the feature data in response to a search request from the search processing apparatus 4 is very useful for investigations in the police.

The degree of accuracy of the feature data is high by performing comparison and classification on the basis of, for example, face data Fa and Fb shown in FIG. 19. Furthermore, the degree of accuracy of the determination as to the same person can be increased by also using height, weight, the color of the clothes, and the like.

Of course, by comparing the features of a person by the search processing apparatus 4, higher efficiency, shorter required time, and higher accuracy can be realized considerably when compared to the operation for determining whether or not the same person exists while the staff views a video.

The configuration and the processing of the above embodiments are examples, and various modifications of the present invention are possible.

The data storage server 3 is made to be a separate unit from the search processing apparatus 4. In addition, for example, in the computer system 100 serving as the search processing apparatus 4, the feature data DB 43 has been provided in the HDD 109 or the like, and the functions of FIG. 5A may be provided so that the data storage server 3 and the search processing apparatus 4 are integrated as one unit.

Various modifications of the configuration and the operation of the image-capturing apparatus 1 can be considered. A microphone may be provided so that audio is recorded together with images. In that case, when an image request occurs from the search processing apparatus 4, audio data can be transmitted together with image data, so that the audio at the time of image capturing can be confirmed on the search processing apparatus 4 side.

Feature data is generated with respect to an image-captured person. There is no need to limit the object to a person. For example, when an automobile is a subject, the feature data (color and automobile type) of the automobile may be generated, so that, for example, a search for an automobile that has moved from place A to place B is performed on the search processing apparatus 4 side is performed.

In the embodiment, the search system of this example has been described as being a system used by the police and furthermore, the search system can also be applied as a system used for other than the police.

The program according to the embodiment of the present invention can be implemented as a program for enabling the controller 21 of the image-capturing apparatus 1 to perform processing according to an embodiment of the present invention. Furthermore, the program according to the embodiment of the present invention can be implemented as a program for enabling the computer system 100 serving as the search processing apparatus 4 to perform processing of FIGS. 8 to 11.

The programs can be recorded in advance in a system HDD serving as a recording medium in the information processing apparatus, such as a computer system, a ROM in a microcomputer having a CPU, or the like.

Alternatively, the programs can be temporarily or permanently stored (recorded) on a removable recording medium, such as a flexible disk, a CD-ROM (Compact Disc Read Only Memory), an MO (Magneto optical) disc, a DVD (Digital Versatile Disc), a magnetic disk, or a semiconductor memory. Such a removable recording medium can be provided in the form of packaged software. Since the program is provided in the form of, for example, a CD-ROM, a DVD-ROM, or the like, it can be installed into a computer system.

In addition to being installed from a removable recording medium, the programs can be downloaded from a download site via a network, such as a LAN (Local Area Network) or the Internet.

It should be understood by those skilled in the art that various modifications, combinations, sub-combinations and alterations may occur depending on design requirements and other factors insofar as they are within the scope of the appended claims or the equivalents thereof.

What is claimed is:

1. A search system comprising:
a plurality of image-capturing apparatuses that are fixedly installed at different places;
a data storage apparatus; and
an information processing apparatus,
wherein each of the image-capturing apparatuses includes
an image capturer configured to obtain image data by performing image capturing,
a recording and reproduction section configured to record the image data obtained by the image capturer on a recording medium,
a feature data generator configured to analyze the image data obtained by the image capturer and generate feature data of a subject,
a transmission data generator configured to generate, as transmission data, a feature data unit containing at least the feature data and image-capturing apparatus identification information given to individual image-capturing apparatuses, and
a transmitter configured to transmit the feature data unit generated by the transmission data generator to the data storage apparatus,
wherein the data storage apparatus includes
a database, and
a register configured to register the feature data units transmitted from the image-capturing apparatuses in the database so as to be stored, and
wherein the information processing apparatus includes
a condition input section configured to accept, as an input conditions, an input for specifying plural image-capturing apparatuses among the plurality of image-capturing apparatuses,
an obtaining section configured to obtain the feature data units associated with the image-capturing apparatuses specified by the process of the condition input section from the database,
a classification and extraction section configured to classify each feature data unit obtained by the obtaining section on the basis of the feature data contained in the feature data unit and configured to extract a plurality of feature data units having identical or similar feature data as a feature data group, and
a display processor configured to display and output information on the feature data group extracted by the classification and extraction section.

2. The search system according to claim 1, wherein the transmission data generator of the image-capturing apparatus further generates a feature data unit containing date and time information indicating image-capturing date and time of image data associated with the feature data,
the condition input section of the information processing apparatus accepts, as input conditions, the specifying of a plurality of image-capturing apparatuses and also the specifying of date and time for each specified image-capturing apparatus, and
the obtaining section of the information processing apparatus obtains the feature data unit corresponding to the date and time specified by each specified image-capturing apparatus from the database.

3. An image-capturing apparatus that is installed at a predetermined place and that is capable of communicating with at least an external data storage apparatus, the image-capturing apparatus comprising:
an image capturer configured to obtain image data by performing image capturing;
a recording and reproduction section configured to record the image data obtained by the image capturer on a recording medium;
a feature data generator configured to analyze the image data obtained by the image capturer and generate feature data of a subject;
a transmission data generator configured to generate, as transmission data, a feature data unit containing at least the feature data and image-capturing apparatus identification information given to individual image-capturing apparatuses; and
a transmitter configured to transmit the feature data unit generated by the transmission data generator to the data storage apparatus.

4. The image-capturing apparatus according to claim 3, wherein the recording and reproduction section records the image data obtained by the image capturer, together with date and time information indicating image-capturing date and time, on a recording medium.

5. The image-capturing apparatus according to claim 3, wherein the transmission data generator generates a feature data unit containing date and time information indicating image-capturing date and time of image data related to the feature data.

6. The image-capturing apparatus according to claim 3, wherein the transmission data generator further generates a feature data unit containing image data related to the feature data.

7. The image-capturing apparatus according to claim 3, wherein the feature data generator extracts image data corresponding to a person as a subject of the image data obtained by the image capturer and generates feature data regarding the person on the basis of the extracted image data.

8. The image-capturing apparatus according to claim 3, further comprising a sensor configured to detect information regarding a subject captured by the image capturer,
wherein the feature data generator generates the feature data on the basis of the detection information obtained by the sensor.

9. The image-capturing apparatus according to claim 3, further comprising an image transmission controller configured to, in response to image request information received from an external information processing apparatus, allow the recording and reproduction section to read image data specified by the image request information and allow the communication section to transmit the image data to the information processing apparatus.

10. The image-capturing apparatus according to claim 3, further comprising a search process controller configured to perform
a process for setting feature data contained in the search request information as an object to be searched for in response to search request information received from an external information processing apparatus; and
a process for determining whether or not the feature data generated by the feature data generator matches the feature data that is set as an object to be searched for and for making a notification to the information processing apparatus when the feature data match.

11. The image-capturing apparatus according to claim 3, further comprising an amount-of-data-reduction process controller configured to allow the recording and reproduction section to perform an amount-of-stored-data-reduction process for reducing the amount of image data for which a predetermined period of time has passed from the time of recording from within the image data recorded on the recording medium.

12. A data storage apparatus capable of communicating with a plurality of image-capturing apparatuses that are fixedly installed at different places, the data storage apparatus comprising:
a database; and
a register configured to register feature data units transmitted from the image-capturing apparatuses in the database so as to be stored.

13. An information processing apparatus comprising:
a condition input section configured to accept, as input conditions, an input for specifying plural image-capturing apparatus among a plurality of image-capturing apparatuses that are fixedly installed at different places;
an obtaining section configured to obtain a feature data unit related to each image-capturing apparatus specified by the process of the condition input section from a database in which feature data units that are generated by the plurality of image-capturing apparatuses and that contain the feature data of subjects are registered;
a classification and extraction section configured to classify each feature data unit obtained by the obtaining section on the basis of the feature data contained in the feature data unit and configured to extract a plurality of feature data units having identical or similar feature data as a feature data group; and
a display processor configured to display and output information on the feature data group extracted by the classification and extraction section.

14. The information processing apparatus according to claim 13,
wherein the condition input section accepts, as input conditions, the specifying of a plurality of image-capturing apparatuses and also the specifying of date and time for each image-capturing apparatus, and
the obtaining section obtains the feature data unit corresponding to the date and time specified by each specified image-capturing apparatus from the database.

15. The information processing apparatus according to claim 13, further comprising an image request transmitter configured to transmit image request information for making a request for an image corresponding to a feature data unit contained in the feature data group extracted by the classification and extraction section to the image-capturing apparatus that has generated the feature data unit,
wherein the display processor displays and outputs the image data transmitted from the image-capturing apparatus in response to the image request information.

16. The information processing apparatus according to claim 13, further comprising a search request transmitter configured to generate search request information containing the feature data in the feature data unit and transmit the search request information to each of the image-capturing apparatuses.

17. A captured-image processing method for use with an image-capturing apparatus that is installed at a predetermined place and that is capable of communicating with at least an external data storage apparatus, the captured-image processing method comprising the steps of:
obtaining image data by performing image capturing;
recording the image data obtained in the image capturing on a recording medium;
analyzing the image data obtained in the image capturing and generating feature data of a subject;
generating, as transmission data, a feature data unit containing at least the feature data and image-capturing apparatus identification information given to individual image-capturing apparatuses; and
transmitting the feature data unit generated in the transmission data generation to the data storage apparatus.

18. An information processing method comprising the steps of:
accepting, as input conditions, an input for specifying plural image-capturing apparatus among a plurality of image-capturing apparatuses that are fixedly installed at different places;
obtaining a feature data unit related to each image-capturing apparatus specified in the condition input from a database in which feature data units that are generated by the plurality of image-capturing apparatuses and that contain the feature data of subjects are registered;
classifying each feature data unit obtained in the obtainment on the basis of the feature data contained in the feature data unit and extracting a plurality of feature data units having identical or similar feature data as a feature data group; and
displaying and outputting information on the feature data group extracted in the classification and extraction.

19. A program for enabling an image-capturing apparatus that is installed at a predetermined place and that is capable of communicating with at least an external data storage apparatus to perform a method comprising the steps of:
obtaining image data by performing image capturing;
recording the image data obtained in the image capturing on a recording medium;
analyzing the image data obtained in the image capturing and generating feature data of a subject;
generating, as transmission data, a feature data unit containing at least the feature data and image-capturing apparatus identification information given to individual image-capturing apparatuses; and
transmitting the feature data unit generated in the transmission data generation to the data storage apparatus

20. A program for enabling an information processing apparatus to perform a method comprising the steps of:
accepting, as input conditions, an input for specifying plural image-capturing apparatus among a plurality of image-capturing apparatuses that are fixedly installed at different places;
obtaining a feature data unit related to each image-capturing apparatus specified in the condition input from a database in which feature data units that are generated by the plurality of image-capturing apparatuses and that contain the feature data of subjects are registered;
classifying each feature data unit obtained in the obtainment on the basis of the feature data contained in the feature data unit and extracting a plurality of feature data units having identical or similar feature data as a feature data group; and
displaying and outputting information on the feature data group extracted in the classification and extraction.
